(19) United States
(12) Patent Application Publication
(10) Pub. No.: US 2021/0329005 A1
(43) Pub. Date: Oct. 21, 2021

(54) Authenticated transmission of data content over a communication link

(71) Applicant: Simon Ellis Locke, Hobart (AU)

(72) Inventor: Simon Ellis Locke, Hobart (AU)

(21) Appl. No.: 14/760,474

(22) PCT Filed: Jan. 14, 2013
(86) PCT No.: PCT/AU2013/000023

§ 371 Date: Jul. 12, 2015

(30) Foreign Application Priority Data
Jan. 13, 2012 (AU) 2012900130
Jan. 16, 2012 (AU) 2012900191
May 1, 2012 (AU) 2012901764
May 7, 2012 (AU) 2012901861
Jul. 12, 2012 (AU) 2012902988
Jul. 31, 2012 (AU) 2012903271

(51) Int. Cl. H04L 29/06; H04L 12/26

(52) U.S. Cl. CPC H04L 63/123; H04L 63/1475; H04L 63/0428; H04L 43/0847; H04L 65/1069; H04L 43/16

(57) ABSTRACT

Described embodiments relate generally to methods for communication between a first computer and a second computer over a network and to computers configured to detect a corruption of such communication. Particular embodiments apply to streamed video and/or audio data transmitted from one party to another or between both parties. Embodiments are generally concerned with communication techniques that allow determination of whether communication between the two parties may have been corrupted, for example by an unauthorised third party.

### TECHNICAL FIELD

Described embodiments relate generally to methods for communication between a first computer and a second computer over a network and to computers configured to detect a corruption of such communication.

### BACKGROUND

Authentication of data is widely required in commerce. We wish to know whether data has been modified in transit to and/or from another party. This may be data constituting an electronic document or digital photo. Also we often wish to encrypt data in transit so that it cannot be read by a third party. This may be data constituting a sensitive email, electronic document, digital photo, telephone call or video call. Encryption requires pre-sharing secret data or at least reliably sharing some data (such as a public key). Thus ways, particularly more convenient ways than exchanging data verbally, of sharing some data reliably between two parties remotely without involving a third party may be valued for encryption.

It would be useful for a party to have a secret that it can control the release of, that although not pre-known by another party, can be verified by another party that it was a recent secret of the sending party. Such a secret may allow another party to authenticate data as being from the source of the secret.

Described embodiments attempt to address or ameliorate one or more shortcomings or disadvantages of prior communication techniques, or to at least provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Some embodiments relate to a method of communication between a first computer and a second computer over a network, the method comprising:
establishing a data communication session between the first computer and the second computer;
receiving in real time at the first computer a secure source of streamed first video and/or audio data;
generating an encoded representation of at least a first part of the first video and/or audio data, wherein the encoded representation further comprises data to be authenticated by the second computer as being from the first computer;
transmitting the encoded representation to the second computer;
transmitting at least a second part of the first streamed video and/or audio data to the second computer, wherein the at least first part of the first video and/or audio data has a first continuity relationship with the at least second transmitted first streamed video and/or audio data;
receiving a first part of second streamed video and/or audio data purportedly from the second computer;
receiving at the first computer a second part of the second streamed video and/or audio data purportedly from the second computer and displaying at the first computer images and/or sound corresponding to the second part of the second streamed video and/or audio data, wherein the second part of the second streamed video and/or audio data comprises feedback video and/or audio data responsive to at least another part of the transmitted first streamed video and/or audio data;
determining whether the first part of second streamed video and/or audio data has a predetermined second continuity relationship with the second part of the second streamed video and/or audio data; and
determining the existence of a communication corruption if it is determined that the first part of second streamed video and/or audio data and the second part of the second streamed video and/or audio data do not have the predetermined second continuity relationship.

The encoded representation may be generated by the first computer using a selected part of the secure source of streamed first video and/or audio as the first part of the first video and/or audio data, and the selected part may be based on the data to be authenticated. The selected part may be determined based on an output of at least one mathematical function that is applied by the first computer to the data to be authenticated to specify one of a plurality of selection masks to be used by the first computer in generating the encoded representation.

The encoded representation may comprise a plurality of selected parts of the secure source of streamed first video and/or audio data as the first part of the first video and/or audio data, and the transmitting of the encoded representation may comprise transmitting different ones of the selected parts at selected times within a predetermined period after establishing the data communication session. The selected times may be determined based on an output of at least one mathematical function that is applied by the first computer to the data to be authenticated.

The at least first part of the first video and/or audio data may not be recoverable from the encoded representation, and the method may further comprise transmitting to the second computer one of: the at least first part of the first video and/or audio data; and recovery data that allows recovery of the at least first part of the first part of the first video and/or audio data.

The first continuity relationship may require that image features and/or audio features of respective first video and/or audio data are consistent between the transmitted first streamed video and/or audio data and the at least first part of the first video and/or audio data, such that an error metric between the transmitted first streamed video and/or audio data and the at least first part of the first video and/or audio data is satisfied to within a predetermined error threshold.

The second continuity relationship may require that image features and/or audio features of respective second video and/or audio data are consistent between the first part of second streamed video and/or audio data and the second part of second streamed video and/or audio data, such that an error metric between the first part of second streamed video and/or audio data and the second part of second streamed video and/or audio data is satisfied to within a predetermined error threshold.

Some embodiments relate to a method of communication between a first computer and a second computer over a network, the method comprising:
establishing a data communication session between the first computer and the second computer;
receiving in real time at the first computer a secure source of streamed first video and/or audio data;
receiving an encoded representation of at least a first part of second streamed video and/or audio data purportedly from the second computer, wherein the encoded representation further comprises data to be authenticated by the first computer as being from the second computer;
transmitting at least a first part of the first video and/or audio data to the second computer;
transmitting at least a second part of the first streamed video and/or audio data to the second computer, wherein the at least second part of the first streamed video and/or audio data has a first continuity relationship with the transmitted first part of the first video and/or audio data;
receiving at the first computer a second part of the second streamed video and/or audio data purportedly from the second computer and displaying at the first computer images and/or sound corresponding to the second part of the second streamed video and/or audio data, wherein the second part of the second streamed video and/or audio data comprises feedback video and/or audio data responsive to at least another part of the transmitted first streamed video and/or audio data;
determining whether the first part of second streamed video and/or audio data has a predetermined second continuity relationship with the second part of the second streamed video and/or audio data; and
determining the existence of a communication corruption if it is determined that the first part of second streamed video and/or audio data and the second part of the second streamed video and/or audio data do not have the predetermined second continuity relationship.

The at least first part of the first video and/or audio data may not be recoverable from the encoded representation, and the method may further comprise receiving at the first computer purportedly from the second computer one of: the at least first part of the first video and/or audio data; and recovery data that allows recovery by the first computer of the at least first part of the first part of the first video and/or audio data.

The first continuity relationship may require that image features and/or audio features of respective first video and/or audio data are consistent between the transmitted first streamed video and/or audio data and the at least first part of the first video and/or audio data, such that an error metric between the transmitted first streamed video and/or audio data and the at least first part of the first video and/or audio data is satisfied to within a predetermined error threshold.

The second continuity relationship may require that image features and/or audio features of respective second video and/or audio data are consistent between the first part of second streamed video and/or audio data and the second part of second streamed video and/or audio data, such that an error metric between the first part of second streamed video and/or audio data and the second part of second streamed video and/or audio data is satisfied to within a predetermined error threshold.

The method may further comprise flagging the communication corruption if it is determined to exist. The flagging may comprise at least one of: logging the occurrence of the communication corruption in data records of the first computer; and providing a visual and/or audio and/or sensory indication of the existence of the communication corruption via the first computer. The method may further comprise terminating the data communication session if the communication corruption is determined to exist.

Some embodiments relate to a system comprising means for performing any of the methods described herein.

Some embodiments relate to computer-readable storage storing executable program code which, when executed by a computer, causes the computer to perform any of the methods described herein.

Some embodiments relate to a first computer configured for communication with a second computer over a network, the first computer comprising:
a call initialisation module for establishing a data communication session between the first computer and the second computer;
a video and/or audio capture module for receiving in real time at the first computer a secure source of streamed first video and/or audio data;
an encoding module for generating an encoded representation of at least a first part of the first video and/or audio data, wherein the encoded representation further comprises data to be authenticated by the second computer as being from the first computer;
a communication module configured to transmit the encoded representation to the second computer and to transmit at least a second part of the first streamed video and/or audio data to the second computer, wherein the at least first part of the first video and/or audio data has a first continuity relationship with the at least second transmitted first streamed video and/or audio data;
the communication module being further configured to receive a first part of second streamed video and/or audio data purportedly from the second computer and to receive a second part of the second streamed video and/or audio data purportedly from the second computer;
a user interface module for displaying at the first computer images and/or sound corresponding to the second part of the second streamed video and/or audio data, wherein the second part of the second streamed video and/or audio data comprises feedback video and/or audio data responsive to at least another part of the transmitted first streamed video and/or audio data;
a continuity checking module for determining whether the first part of second streamed video and/or audio data has a predetermined second continuity relationship with the second part of the second streamed video and/or audio data; and
a communication corruption detection module for determining the existence of a communication corruption if the continuity checking module determines that the first part of second streamed video and/or audio data and the second part of the second streamed video and/or audio data do not have the predetermined second continuity relationship.

The encoded representation may be generated by the encoding module using a selected part of the secure source of streamed first video and/or audio as the first part of the first video and/or audio data, wherein the selected part is based on the data to be authenticated. The selected part may be determined by the encoding module based on an output of at least one mathematical function that is applied by the encoding module to the data to be authenticated to specify one of a plurality of selection masks to be used by the encoding module in generating the encoded representation.

The encoded representation may comprise a plurality of selected parts of the secure source of streamed first video and/or audio data as the first part of the first video and/or audio data, and the transmission of the encoded representation by the communication module may comprise transmitting different ones of the selected parts at selected times within a predetermined period after establishing the data communication session. The selected times may be determined based on an output of at least one mathematical function that is applied by the encoding module to the data to be authenticated.

The at least first part of the first video and/or audio data may not be recoverable from the encoded representation, and the communication module may be further configured to transmit to the second computer one of: the at least first part of the first video and/or audio data; and recovery data that allows recovery of the at least first part of the first part of the first video and/or audio data.

The first continuity relationship may require that image features and/or audio features of respective first video and/or audio data are consistent between the transmitted first streamed video and/or audio data and the at least first part of the first video and/or audio data, such that an error metric between the transmitted first streamed video and/or audio data and the at least first part of the first video and/or audio data is satisfied to within a predetermined error threshold.

The second continuity relationship may require that image features and/or audio features of respective second video and/or audio data are consistent between the first part of second streamed video and/or audio data and the second part of second streamed video and/or audio data, such that an error metric between the first part of second streamed video and/or audio data and the second part of second streamed video and/or audio data is satisfied to within a predetermined error threshold.

Some embodiments relate to a first computer configured for communication with a second computer over a network, the first computer comprising:
a call initialisation module for establishing a data communication session between the first computer and the second computer;
a video and/or audio capture module for receiving in real time at the first computer a secure source of streamed first video and/or audio data;
a communication module configured to:
   receive an encoded representation of at least a first part of second streamed video and/or audio data purportedly from the second computer, wherein the encoded representation further comprises data to be authenticated by the first computer as being from the second computer,
   transmit at least a first part of the first video and/or audio data to the second computer, transmit at least a second part of the first streamed video and/or audio data
   to the second computer, wherein the at least second part of the first streamed video and/or audio data has a first continuity relationship with the transmitted first part of the first video and/or audio data, and
   receive at the first computer a second part of the second streamed video and/or audio data purportedly from the second computer;
a user interface module to display at the first computer images and/or sound corresponding to the second part of the second streamed video and/or audio data, wherein the second part of the second streamed video and/or audio data comprises feedback video and/or audio data responsive to at least another part of the transmitted first streamed video and/or audio data;
a continuity checking module to determine whether the first part of second streamed video and/or audio data has a predetermined second continuity relationship with the second part of the second streamed video and/or audio data; and
a communication corruption detection module for determining the existence of a communication corruption in response to the continuity checking module determining that the first part of second streamed video and/or audio data and the second part of the second streamed video and/or audio data do not have the predetermined second continuity relationship.

The at least first part of the first video and/or audio data may not be recoverable from the encoded representation, and the communication module may be configured to receive purportedly from the second computer one of: the at least first part of the first video and/or audio data; and recovery data that allows recovery by the first computer of the at least first part of the first part of the first video and/or audio data.

The first continuity relationship may require that image features and/or audio features of respective first video and/or audio data are consistent between the transmitted first streamed video and/or audio data and the at least first part of the first video and/or audio data, such that an error metric between the transmitted first streamed video and/or audio data and the at least first part of the first video and/or audio data is satisfied to within a predetermined error threshold.

The second continuity relationship may require that image features and/or audio features of respective second video and/or audio data are consistent between the first part of second streamed video and/or audio data and the second part of second streamed video and/or audio data, such that an error metric between the first part of second streamed video and/or audio data and the second part of second streamed video and/or audio data is satisfied to within a predetermined error threshold.

The communication corruption detection module may be further configured to flag the communication corruption if it is determined to exist, wherein the flagging comprises at least one of: logging the occurrence of the communication corruption in data records of the first computer; and providing a visual and/or audio and/or sensory indication of the existence of the communication corruption via the first computer. The communication corruption detection module may be further configured to terminate the data communication session if the communication corruption is determined to exist.

Some embodiments relate to a method for transmitting data content from a first party to a second party such that the second party can verify that the data content is associated with real-time audio and/or video data from the first party, the method comprising a first party:
sending data content to a second party;
sending real-time audio and/or video data to the second party, wherein the real-time audio and/or video data is such that the second party can verify the real-time audio and/or video data as being, or having been, sent by the first party;
sending continuity data to the second party, wherein the continuity data relates to the real-time audio and/or video data according to a verifiable continuity relationship; and
sending bound data to the second party, wherein the bound data binds (i) the data content with (ii) the continuity data, according to a binding relationship, such that the bound data is secure to the extent that it is impossible for a third party such as a man-in-the-middle attacker to substitute data content with all possible alternative data content without detection.

Some embodiments relate to a method for a second party to receive data content from a first party such that the second party can verify that the data content is associated with real-time audio and/or video data from the first party, the method comprising a second party:
receiving data content from a first party;
receiving real-time audio and/or video data from the first party, wherein the real-time audio and/or video data is such that the second party can verify the real-time audio and/or video data as being, or having been, sent by the first party;
receiving continuity data from the first party, wherein the continuity data relates to the real-time audio and/or video data according to a verifiable continuity relationship; and
receiving bound data to the second party, wherein the bound data binds (i) the data content with (ii) the continuity data, according to a binding relationship, such that the bound data is secure to the extent that it is impossible for a third party such as a man-in-the-middle attacker to substitute data content with all possible alternative data content without detection.

Thus it will be seen by those skilled in the art that, in accordance with some embodiments, the first party sends real-time audio and/or video data to the second party that is linked by verifiable continuity and binding relationships to the data content. The second party may thus verify the source or authenticity of the (potentially arbitrary) data content by verifying that the real-time audio and/or video data (which may be in a prescribed format) was sent by the first party. The problem of authenticating arbitrary data content can thus be reduced to the relatively straightforward task of verifying that particular real-time audio and/or video data has indeed been sent by the first party. There is no need for the parties to have previously shared a cryptographic key or to rely on a public-key infrastructure.

The first party may stream the audio or video data to the second party.

Verifying the source or authenticity of streamed audio or video data can often be done with relative ease by human and/or automated means. For instance, in some embodiments, the stream may be part of an interactive videoconference call between the first and second parties, and a party can thus determine that the streamed data is being transmitted by the other party by recognising the face or voice of the other party and by engaging in live dialogue with that person.

The first party may receive an influence message or influence data from the second party, and the real-time audio and/or video data may relate to the influence message or data according to a verifiable feedback relationship. Verification of the feedback relationship may comprise determining that a response to the influence data occurs within a maximum time interval. The influence message or data may take any suitable form. For instance, it may comprise a command for a person appearing in the streamed video data to wave his right hand, and the second party may then determine whether the subsequent streamed data shows the person waving his right hand, within an appropriate time period after sending the influence data. Alternatively, it may comprise a question, such as “How is your health?” and checking for a consistent or correct answer. While such questioning may rely on shared knowledge between the parties, it will be appreciated that the possession of such shared knowledge is not essential in some embodiments and is, in any case, a quite different matter from having to share passwords or encryption keys ahead of time as is done in certain alternative approaches to authenticating a message (although this is not excluded).

More generally, a party may transmit an influence message or influence data to the other party to ensure that a received audio or video stream is real-time or near real-time (e.g. allowing for some transmission and/or buffering delays), by determining whether the later-received streamed audio or video data is affected by the influence message or data.

The real-time audio and/or video data may be such that the second party can verify the real-time audio and/or video data as being sent by the first party (e.g. with ongoing streamed data), or as having recently been sent by the first party; e.g. within the last ten seconds, or any other maximum time delay. This can help avoid replay attacks. While the use of influence data is one way of achieving this, it may be done in other ways; for instance if the real-time audio and/or video data comprises a video of the first party with a television set in the background showing live news footage. It will be appreciated that a verifiable relationship, as used herein, is not necessarily verifiable with absolute certainty, but should be capable of being verified with a low probability of incorrect verification (e.g. to within a predetermined confidence level).

The method according to some embodiments may be carried out in any order, except where otherwise indicated or implied in the context of a particular embodiment.

The data content may take any form. It may, for instance, comprise an electronic document or a public cryptographic key belonging to the first party. The data content may be sent by any suitable mechanism or encoding. It may, for instance, be sent as binary data packets over a data network. While the data content may be sent separately from other transmissions, in some embodiments, the data content is encoded in or by the sending of one or more of the real-time audio and/or video data, continuity data and bound data. Such encoding may take various forms. One or more of the real-time audio and/or video data, continuity data and bound data may comprise or encode some or all of the data content. Alternatively or additionally, the timing of the sending of one or more of the real-time audio and/or video data, continuity data and bound data may encode some or all of the data content. These options are explained in more detail below.

In embodiments in which the continuity data encodes the data content, the continuity data may itself form the bound data. The binding relationship may then be that the bound data (i) encodes the data content and (ii) is made up of the continuity data.

In other embodiments, however, the bound data is such that it does not reveal the continuity data. In such embodiments the continuity data may only be revealed such that it is possible to verify that the bound data was received before the continuity data was revealed.

The data content may be sent and/or received over a communication link. The communication link may be any form of data communication link, e.g. comprising a wire for electrical signals and/or a fibre optical cable for optical signals. It may comprise or use equipment for transmitting data wirelessly, e.g. by radio, microwave or laser beam. It may comprise any number of intermediate nodes such as relays, routers or gateways. It may just connect the first and second parties, or it may be part of a larger network, also connected to other parties. It may form part or all of a public network, such as the Internet. The data content may be sent and/or received as an electronic signal, an optical signal, a radio signal, a sonic signal, or in any other appropriate way. Each of the transmissions may be made through the same or a different medium.

Some embodiments are arranged such that one or both parties can verify that the bound data is received by the second party before any first-party data is sent by the first party that could be used by a third party (e.g. a man-in-the-middle attacker) to create alternative bound data that binds (i) alternative data content with (ii) the first-party data, according to the binding relationship. This may be accomplished in various different ways, as described in more detail below.

In some embodiments, the second party receives the bound data and thereafter sends a verifiable secret to the first party; and the first party receives the verifiable secret and thereafter transmits the continuity data to the second party. In some embodiments the second party may transmit the verifiable secret prior to receiving the first bound data.

The verifiable secret may take various forms but is such that the first party can use it to determine that the verifiable secret was, or is being, transmitted by the second party. It could be any data only available to the second party that has not been revealed by the second party. Some embodiments allow any data content to be associated with second real-time audio and/or video data. Thus the verifiable secret may even comprise a random number selected by the second party that is later verified to have been sent by the second party. Conveniently the verifiable secret may comprise second continuity data which the second party transmits to the first party, wherein the second continuity data relates to the second real-time audio and/or video data according to a second verifiable continuity relationship (which may be the same as the first verifiable continuity relationship). The first party may receive second real-time audio and/or video data and may determine from the second real-time audio and/or video data that the second real-time audio and/or video data is being streamed by the second party. The second real-time audio and/or video data may comprise the face or voice of the second party. The first party may send second influence data to the second party, and the second real-time audio and/or video data may relate to the second influence data according to a verifiable influence relationship (which may be the same as or different from the aforementioned influence relationship). Second continuity data, representing a verifiable secret may, for instance, comprise the start of a stream of audio or video data, which may be transmitted over the communication link. It may, instead, comprise the start of a telephone call from the second party to the first party, or other communication over a separate channel from that over which the data content is transmitted. In some embodiments, the second party may send the real-time audio and/or video data to the first party after receiving the first continuity data.

Depending on the nature of the verifiable secret, the first party may verify that the verifiable secret was, or is being, transmitted by the second party before or after or while transmitting the continuity data to the second party, and before or after or while transmitting the first real-time audio and/or video data to the second party.

Instead of comprising second continuity data itself, the verifiable secret may comprise second bound data, wherein the second bound data relates to at least such second continuity data and second data content according to a second binding relationship.

In some embodiments, the first binding relationship may differ from the second binding relationship, but in some embodiments they are the same. This can simplify implementation and use.

In some embodiments, the first party may receive second continuity data and may verify that that the second continuity data relates to the second real-time audio and/or video data according to the second verifiable continuity relationship.

In some embodiments, the first party may receive second bound data and may verify that it relates to the received second continuity data and second data content according to the second binding relationship.

In some embodiments the second party receives the data content, the bound data and the continuity data and verifies that the received bound data relates to the received data content and the received continuity data according to the binding relationship. In some embodiments the second party receives the continuity data and real-time audio and/or video data, and verifies that the continuity data relates to real-time audio and/or video data according to the continuity relationship. In some embodiments the second party receives the real-time audio and/or video data and determines that the real-time audio and/or video data was, or is being, sent by the first party.

Some embodiments relate to a method of verifying that received data content is associated with received real-time audio and/or video data, the method comprising:
verifying that received continuity data relates to received real-time audio and/or video data according to a continuity relationship; and
verifying that received bound data binds (i) the data content with (ii) the continuity data, according to a binding relationship; and
ensuring that received bound data is secure to the extent that it was impossible for a third party such as a man-in-the-middle attacker to substitute data content with all possible alternative data content without detection.

In some embodiments, if the first and/or second party determines that a verification has failed, it alerts the other party and/or ceases its transmissions. Thus, if all verifications are completed without receiving any alerts, the second party may reasonably infer that the received data content was transmitted by the first party.

In some embodiments, the second party sends second data content to the first party (whether as a verifiable secret or not). The second party may send second real-time audio and/or video data to the first party, wherein the second real-time audio and/or video data is such that the first party can verify the second real-time audio and/or video data as being, or having been, sent by the second party. The second party may send second continuity data to the second party, wherein the second continuity data relates to the second real-time audio and/or video data according to a second verifiable continuity relationship (which may be the same as the first verifiable continuity relationship). In some embodiments the second party transmits second bound data, wherein the second bound data binds (i) the second data content with (ii) the second continuity data, according to a second binding relationship (which may be the same as the first binding relationship), such that the second bound data is secure to the extent that it is impossible for a third party such as a man-in-the-middle attacker to substitute second data content with all possible alternative second data content without detection. In some embodiments, the first party verifies that the received second bound data binds the received second data content and the received second continuity data, according to the second binding relationship.

In this way, some embodiments can be used for exchanging data content between the first and second parties that is linked to real-time audio and/or video data of the sender of the data content.

In some embodiments, the data content from each party comprises a respective cryptographic key or other data suitable for use in a key-exchange protocol. In some embodiments the first and second parties use the respective received data contents to generate a shared session key; for example, using a Diffie-Hellman key exchange. They may then exchange data clandestinely by encrypting it using the session key.

Some embodiments are arranged such that one or both parties can verify that the second bound data is received by the first party before any second-party data is sent by the second party that could be used by a third party (e.g. a man-in-the-middle attacker) to create alternative second bound data that binds (i) alternative data content with (ii) the second-party data, according to the second binding relationship.

In some embodiments, the first and/or second real-time audio and/or video data comprises audio or video data. It will be appreciated that audio or video data may include data containing both audio and video content, which may be overlapping or concurrent with each other, and which may be synchronised to each other. The data may comprise three-dimensional video content, video overlaid on three-dimensional laser scans, etc. The data may be compressed or encoded using any suitable algorithm. Streaming is not necessarily continuous and may comprise sending data at intervals, e.g. in a succession of packets. The audio or video data is streamed live or in real time. It will be appreciated that some delay or latency is normally inevitable in live or real-time streaming, due to factors such transmission and reception buffering, network transit times, coding and decoding overheads, etc. In some embodiments, there may be a buffering delay in the streamed data, corresponding to the length of the continuity data. In some embodiments, such a delay may be reduced over time by applying time-compression to at least a portion of the streamed data; i.e. by streaming and rendering the audio or video data in faster than real time for a time.

In some embodiments, the first and/or second verifiable continuity relationships may take any appropriate form. They may relate to a temporal continuity; for instance, the continuity data and the real-time audio and/or video data may both comprise voice data and may be verifiable as being continuous if they form a single continuous monologue when joined together one after the other. The continuity relationships may relate to spatial continuity; for instance, the continuity data and the real-time audio and/or video data may both comprise still or moving image data and may be verifiable as being continuous is they form a single continuous image when joined together one next to the other (e.g. two halves of a picture of a person's head). A continuity relationship between the continuity data and the real-time audio and/or video data may be verified by human and/or automated means, depending on the nature of the continuity relationship. In some embodiments, for instance, the first and/or second continuity data comprises or consists of a portion of audio or video data that relates to audio or video real-time audio and/or video data by being contiguous with the real-time audio and/or video data. In such embodiments, continuity may be verified by listening to and/or observing the transition from the continuity data to the real-time audio and/or video data and checking for the absence of any abrupt change or interruption.

In some embodiments, the first and/or second bound data establish the integrity of the data that they bind according to their respective binding relationships. In other words, they allow a recipient to detect tampering of the data they bind.

In some embodiments, the bound data may be derived using a hash function. It is generated by the transmitting party. Such a hash function may be any function that generates an output based on input data, for which it is infeasible or impossible, given an arbitrary output value, to determine input data that will cause the function to generate that output value. Suitable hash functions will be known to those skilled in the art. The relationship may be different for the first and second bound data (e.g. different hash functions), but in some embodiments it is the same, for ease of implementation.

In some embodiments, other binding relationships are possible which are not based on conventional hash algorithms. For instance, the bound data may relate to its input by comprising some or all of the output of an encryption algorithm (e.g. RSA or AES) applied to some of all of its input. A key for decrypting the bound data may be transmitted by the first party to the second party, before or after transmitting the bound data. If the continuity data and the data content were encrypted with different encryption keys, then the bound data could additionally comprise the hash of the two encryption keys to ensure binding of the data content and the continuity data. On-the-fly generated one time pads could be used as the two encryption keys.

In some embodiments, the first bound data effectively binds the data content to the first continuity data, such that it would be difficult or impossible for an attacker to determine alternative data content to which the first bound data would still relate, when combined with the first continuity data.

Some embodiments can provide protection against man-in-the-middle attacks if the implementation is such the first bound data must be received by the second party before the first party sends or reveals the first continuity data to which it relates. This means that an attacker, wishing to substitute the data content with malicious data content in a way that fools the second party into believing it is authentically transmitted by the first party, would have to intercept the first continuity data and then generate false bound data that validly binds the malicious data content with the first continuity data. However, if the first party does not transmit or reveal (e.g. by transmitting encryption key if encrypted) the first continuity data until after it has received a verifiable secret indicating that the second party has received bound data, purportedly transmitted by the first party, this can be prevented. If the second party receives the genuine first bound data from the first party, then any attempt to tamper with the data content can be detected by the second party. If the second party receives fake bound data (e.g. from an attacker), this fake bound data will not relate to the first continuity data and the second party will detect that the bound data relationship is not valid.

In some embodiments, the first and/or second continuity data may be or comprise a portion of audio or video data. It may relate to the real-time audio and/or video data by being contiguous with a start of, or end of, or break in, a real-time audio and/or video data stream. This portion of audio or video data may be single image (e.g. a single video frame); however, in some embodiments it comprises an audio or video clip of at least a minimum duration, such as at least around 10 milliseconds or one second long.

In some embodiments it is no longer than around five or ten seconds long, so as to avoid introducing excessive latency in the streamed data in situations where this is undesirable (e.g. in videoconference calls).

In some embodiments, the first and/or second continuity data may be or comprise data that relates to the content of the real-time audio and/or video data in some other way. For instance, the continuity data may comprise a portion of audio or video data that relates to the real-time audio and/or video data by reproducing a portion of streamed audio or video real-time audio and/or video data at higher resolution or with greater chromatic information.

The verifiable continuity relationship of the first continuity data may differ from the verifiable relationship of the second continuity data, but in some embodiments they are the same. This can simplify implementation and use.

In some embodiments, the first and/or second continuity data has at least a predetermined minimum entropy rate. It does not, for instance, consist of silence or a succession of blank video frames. In this way, it can be made harder for a man-in-the-middle attacker to guess the content of the continuity data. In some embodiments the continuity data is also different from continuity data and video or audio transmitted previously by the transmitting party.

In some embodiments, the continuity data comprises a portion of audio or video data that is extracted from a sequence of audio or video data, with the remainder of the sequence forming the real-time audio and/or video data. The data portion may, for instance, be a first number (e.g. ninety-nine) frames of video captured from a video camera, with the real-time audio and/or video data commencing from the next (e.g. hundredth) frame onwards. In this way, there is temporal continuity between the continuity data portion and the real-time audio and/or video data, which can be verified by a receiving party.

### BRIEF DESCRIPTION OF THE DRAWINGS

Some embodiments will now be described, by way of example only, with reference to the accompanying drawings, in which:

FIG. 1 is a block diagram of a system comprising first and second parties communicating across a data network in accordance with some embodiments;

FIG. 2 is a block diagram of first and/or second party computing devices in accordance with some embodiments;

FIG. 3 is a block diagram of first and/or second party computing modules in accordance with some embodiments;

FIG. 4 is a block diagram of parties communicating across data networks in accordance with some embodiments;

FIG. 5 is a flowchart of a method of communicating across a data network according to some embodiments;

FIG. 6 is a flowchart of a method of communicating across a data network according to some embodiments;

FIG. 7 is a flowchart of a method of communicating across a data network according to some embodiments;

FIG. 8 is a flowchart of a method of communicating across a data network according to some embodiments;

FIG. 9 is a flowchart of a method of communicating across a data network according to some embodiments;

FIG. 10 is a flowchart of a method of communicating across a data network according to some embodiments;

FIG. 11 is a flowchart of a method of communicating across a data network according to some embodiments;

FIG. 12 is a flowchart of a method of communicating across a data network according to some embodiments;

FIG. 13 is a flowchart of a method of communicating across a data network according to some embodiments;

FIG. 14 is a flowchart of a method of communicating across a data network according to some embodiments;

FIG. 15 is a flowchart of a method of communicating across a data network according to some embodiments;

FIG. 16 is a flowchart of a method of communicating across a data network according to some embodiments;

FIG. 17 is a flowchart of a method of communicating across a data network according to some embodiments;

FIG. 18 is a flowchart of a method of communicating across a data network according to some embodiments;

FIG. 19 is a flowchart of a method of communicating across a data network according to some embodiments;

FIG. 20 is a flowchart of a method of communicating across a data network according to some embodiments;

FIG. 21 is a flowchart of a method of communicating across a data network according to some embodiments; and

FIG. 22 is a flowchart of a method of communicating across a data network according to some embodiments.

### DETAILED DESCRIPTION

As noted above, it would be useful for a party to have a secret that it can control the release of, that although not pre-known by another party, can be verified by another party that it was a recent secret of the sending party. Such a secret may allow another party to authenticate data as being from the source of the secret.

The video and audio sent in real-time video and audio calls could be regarded as a secret of the sending party prior to it being sent. For example a part of a video stream of a person could be regarded as a secret because it is random—naturally a person moves around and does not relocate to exactly the same position. A part of an audio stream of a person could be regarded as a secret because it is random—speech at a particular time from a person has randomness. Real-time feedback may allow verification that a stream was a recent secret of the sending party. Although video and audio call streams possess randomness, they also possess continuity, such that a person moves according to Newtons laws and the speech in a conversation flows. Thus parts of a stream may be related by continuity to the rest of the stream that may be verified as a recent secret of the sending party.

The following description discusses some embodiments that focus on authenticating data used to create a shared session key for secure communications. Alternatively variations of the embodiments could be used to authenticate other data, such as a hash of an electronic document, received from a second party and/or sent to a second party.

Authentication is used to check that data has not been modified in transit to and/or from another party. This may be data constituting an electronic document or digital photo. Encryption is used to prevent eavesdropping by third parties. This may be data constituting a sensitive email, electronic document, digital photo, telephone call or video call. Encryption requires pre-sharing secret data or at least reliably sharing some data (such as a public key). Thus convenient ways of sharing some data reliably between two parties remotely (remote authentication) is useful for encryption.

Real-time audio and/or video of a person has high entropy and is unpredictably random to a third party without access to the audio and/or video. Video is random because naturally a person moves around and does not relocate to exactly the same position. Real-time audio and/or video of a person is typically continuous such that a person moves according to Newton's laws of motion and speech content usually has an approximate sentence/phrase structure and continuous flow of topics. Real-time audio and/or video may contain a feedback response to a recent stimulus and thus indicate that it is real-time. Natural (as observed by a human) real-time audio and/or video of a person containing feedback is generally difficult to create artificially but easy to verify that it is authentic. Therefore controlled release of such audio/video data may be useful for encoding data to authenticate. Parts of the audio/video data used for encoding data that are relatively random on their own may be verified as authentic through continuity with other parts of audio/video. A portion of audio/video may be continuous with portions before and/or after it. At a particular point in time a video signal may be continuous with a lower information video signal that is missing some information.

The following description discusses some embodiments that focus on authenticating data used to create a shared session key for secure communications. These embodiments use controlled release of real-time video/audio data to authenticate data as originating from the source of video/audio data. Alternatively variations of the embodiments described could be used to authenticate other data, such as a hash of an electronic document, received from a second party and/or sent to a second party.

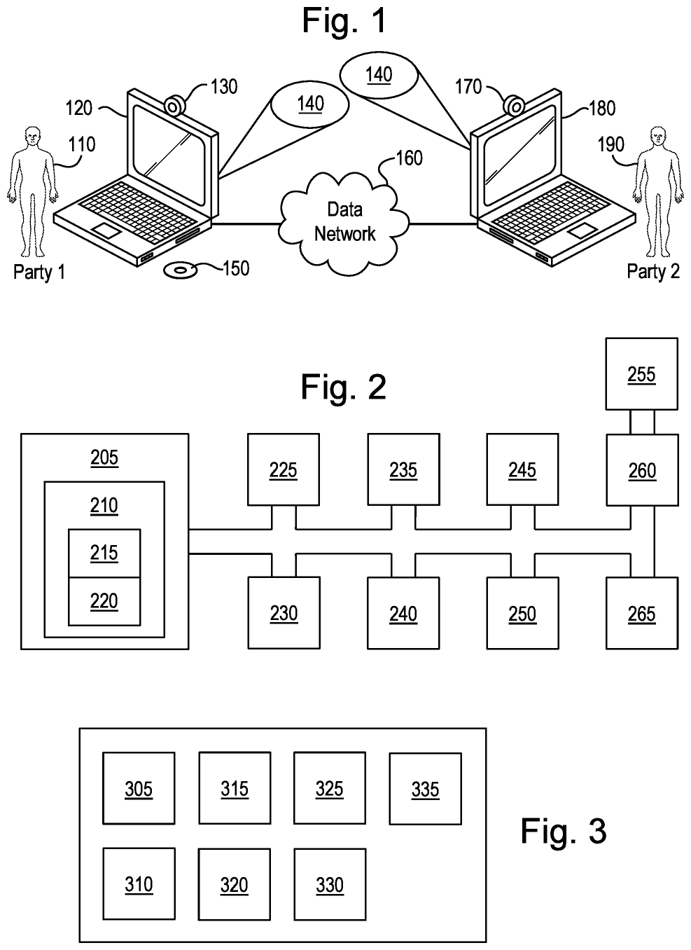

Referring to FIG. 1, there is depicted a block diagram of a system in which a first computational device (computer) 120 is in communication with a second computer 180 over a network 160, such as the Internet or another public or semi-public network.

In some embodiments, computer 120 or computer 180 may be a desktop or mobile computing device e.g. tablet, mobile phone, laptop, smart television, digital radio communications device. Such computers 120 and 180 may include associated peripheral devices. FIG. 2 shows details of computer 120 or computer 180 in some embodiments. In FIG. 2 the numbered items are as follows:

| Item No. | Description |
|---|---|
| 205 | Random access memory (RAM) |
| 210 | Operating system |
| 215 | Video and/or audio calling/conferencing or VoIP application |
| 220 | Stored software instructions and data implementing an |
| | embodiment |
| 225 | Central processing unit (CPU) |
| 230 | Data storage or read only memory (ROM) |
| 235 | Network communication device |
| 240 | User input device e.g. touch screen, keypad, keyboard, mouse |
| 245 | Video camera |
| 250 | Microphone |
| 255 | Display device e.g. LCD display |
| 260 | Graphics processing unit (GPU) |
| 265 | Audio output device e.g. speaker, headphones |

Network communication device 235 interfaces the computer 120 or 180 to data network 160.

FIG. 3 shows details of example computing modules within the stored software 220 in some embodiments. Some embodiments may not have all modules shown and/or may have a different set of modules. In FIG. 3 the numbered items are as follows:

| Item No. | Description |
|---|---|
| 305 | call initialisation module |
| 310 | video and/or audio capture module |
| 315 | encoding module |
| 320 | communication module |
| 325 | user interface module |
| 330 | continuity checking module |
| 335 | communication cormption detection module |

Video and/or audio capture module 310 interfaces to video camera 245 (such as part of device 130 or 170) and/or microphone 250 (such as part of device 130 or 170). Communication module 320 interfaces to network communication device 235. User interface module 325 interfaces to display device 255 and/or user input device 240 and/or audio output device 265.

Personal computer 120 is equipped with a digital camera or “web cam” 130, and runs a suitable software product for video and/or audio calling/conferencing or VoIP 215 within an operating system 210. Skype is one example of a well known video conferencing software that is available. Furthermore, the personal computer 120 also executes a software product 140, which may be the same software product 215 according to some embodiments.

The software product 140 comprises instructions for computer 120 to implement a method according to some embodiments that will shortly be described. The software product 140 may be stored on a storage medium or media, such as a magnetic or optical disk 150, bearing processor-executable instructions for one or more processors 225 of computer 120 to implement a method according to some embodiments that will shortly be described.

The computer 120 is in data communication with other computational devices via a data network 160 such as the internet by means of commonly known communications protocols, such as TCP/IP, via a communication device 235. Computer 120 is able to communicate with devices that are connected to the internet by means of wireless and 3G telephone communications, satellite communications and indeed any other data communication interfaces.

For the purposes of explaining some embodiments, it will be observed that computer 120 is in communication via Internet 160 with a remote computer 180, which is equipped with its own video camera 170 and similar video and/or audio calling/conferencing or VoIP software and also with software product 140. It will be understood that the hardware arrangement including computers 120 and 180 shown in FIG. 1 is for the use of a human operator 110, who will henceforth be referred to as “Party 1” to securely communicate with a second human operator 190, who will henceforth be referred to as “Party 2”. It will be understood that as the context requires, “Party 1” and “Party 2” may mean the individuals 110, 190 as shown in FIG. 1 and/or their associated computers 120, 180.

While some embodiments relate to a simple point to point communication system, a directory based system may also be implemented in some embodiments. Directory services include mapping attributes such as a physical location or physical device or IP address/port or network address or public key to an identifier.

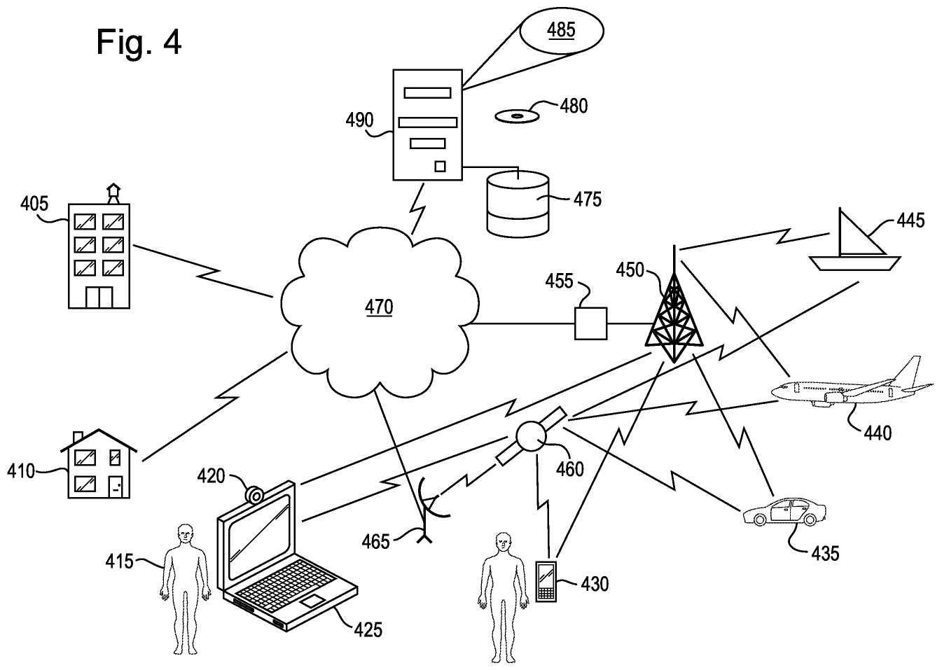

FIG. 4 is a block diagram showing the parties that might be involved in a directory service, according to some embodiments. A party could use a client computing device connected via a secure connection to one or more computing devices such as a server that implements a method according to an embodiment. In FIG. 4 the numbered items are as follows:

| Item No. | Description |
|---|---|
| 405 | Office buildings |
| 410 | Residential buildings |
| 415 | User of system |
| 420 | Video camera |
| 425 | Mobile computing device |
| 430 | Mobile computing device possibly with video camera |
| 435 | Ground vehicle |
| 440 | Aircraft |
| 445 | Water craft |
| 450 | Radio communications network |
| 455 | Radio communications gateway |
| 460 | Satellite |
| 465 | Satellite ground station |
| 470 | Data network, e.g. the Internet |
| 475 | Data storage for software product |
| 480 | Optical/Magnetic disk or other media containing instractions |
| | of the Software Product |
| 485 | Software product for server 490 to implement method |
| | according to an embodiment, or alternatively to provide |
| | lookup of address/attribute of identifier and store |
| | data/manage data |
| 490 | Web/network server programmed to implement method |
| | according to an embodiment, or alternatively to provide |
| | lookup of address/attribute of identifier and store |
| | data/manage data |

Emergency services activities may require physical device/location which could be associated with real-time audio and/or video data using some embodiments. Position data could come from a number of sources possibly including GPS.

Some embodiments may be applied to networks or systems or internets or intranets, where an IP address may not be used. For example, embodiments may be applied to telephone or radio networks that may offer decreased latency.

In some embodiments, transmitting data from one party to another party means any way of the data getting to the other party, including sending data to an intermediate party and providing the other party with access details to the data stored by the intermediate party.

Some embodiments may be used with imperfect communication systems between parties. Techniques, including sending redundant data, encoding redundancy in data sent, error checking and resending data, such as those found in the prior art, could be used to effectively create a high reliability communications channel over imperfect communication systems. This may prevent a method according to an embodiment failing from a communications problem.

In some embodiments, Party 1 and Party 2 establish a new shared session key, according to known prior art techniques; for example a Diffie-Hellman key exchange. A shared session key may be used for encryption of audio and/or video calls, emails, data files or other data transmissions. The new shared session key is established using public data P1 and P2 exchanged between parties (such as data constituting a public key) and private or secret data related to the public data that is not exchanged between parties (such as data constituting a private key). It is necessary to establish that the public data P2′ received by Party 1, purportedly from Party 2, or public data P1′ received by Party 2, purportedly from Party 1, was not substituted by a man-in-the-middle attacker.

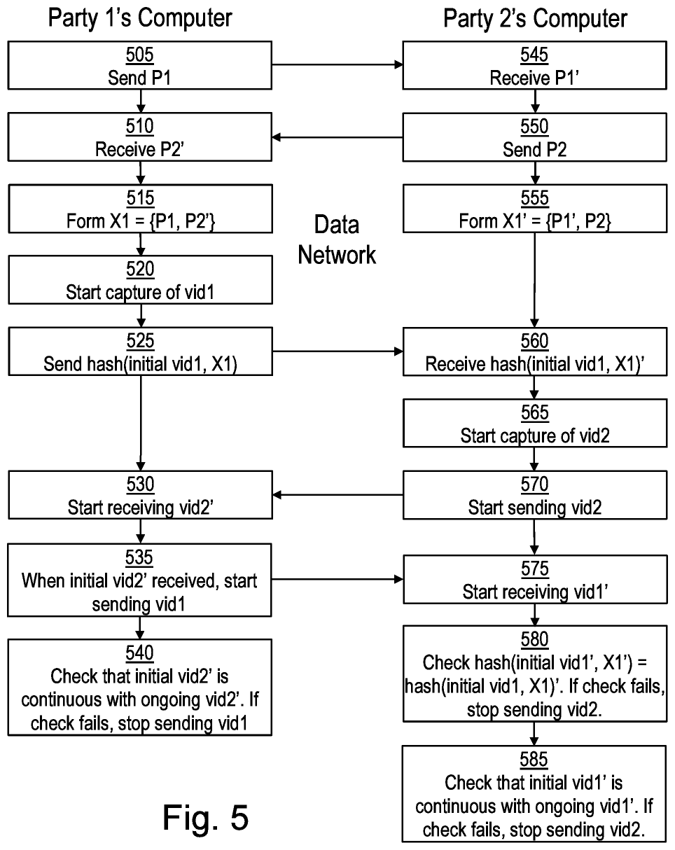

FIG. 5 is a flowchart of a method of communicating between parties with reference to FIGS. 1 to 4 according to some embodiments.

Party 1 call initialisation module 305-1 and Party 2 call initialisation module 305-2 initialise a data communication session. Party 1 communication module 320-1 sends P1 to Party 2 (505) and Party 2 communication module 320-2 receives P1′ purportedly from Party 1 (545). Party 2 communication module 320-2 sends P2 to Party 1 (550) and Party 1 communication module 320-1 receives P2′ purportedly from Party 2 (510). Party 1 call initialisation module 305-1 forms X1 data as the concatenation of P1 and P2′ (515) and Party 2 call initialisation module 305-2 forms X1′ data as the concatenation of P1′ and P2 (555).

Party 1 video and/or audio capture module 310-1 starts capture of Party 1 video vid1 (520). Party 1 encoding module 315-1 applies a hash function to the initial vid1 and to X1 to produce a hash value hash(initial vid1, X1). The hash function may be a cryptographic hash function or other function that binds together initial vid1 and X1 without revealing initial vid1. Party 1 communication module 320-1 sends hash(initial vid1, X1) to Party 2 (525) and Party 2 communication module 320-2 receives hash(initial vid1, X1)′ purportedly from Party 1 (560). Party 2 video and/or audio capture module 310-2 starts capture of Party 2 video vid2 (565). Party 2 communication module 320-2 starts sending vid2 to Party 1 (570) and Party 1 communication module 320-1 starts receiving vid2′ purportedly from Party 2 (530). Once Party 1 communication module 320-1 receives some initial vid2′, such as a frame of vid2′, Party 1 communication module 320-1 sends initial vid1 and starts sending ongoing vid1 to Party 2 (535). Party 2 communication module 320-2 receives initial vid1′ and starts receiving ongoing vid1′ purportedly from Party 1 (575).

Party 2 encoding module 315-2 forms hash′ (initial vid1′, X1′) and Party 2 communication corruption detection module 335-2 performs a check that hash′ (initial vid1′, X1′)=hash(initial vid1, X1)′. If the check fails Party 2 communication corruption detection module 335-2 determines that a communication corruption exists and Party 2 communication module 320-2 stops sending vid2 (580). Hash′ used by Party 2 and the hash function used by Party 1 may be a fixed hash function. However hash′ used by Party 2 and the hash function used by Party 1 may also be one of a variety of hash functions. In this case Party 1 may send an index to the hash function it used to Party 2, or alternatively Party 2 may by brute force perform the check with a variety of possible hash functions until the check does not fail or all hash functions have been tried.

Vid1 and vid2 may include imagery of the faces/body of Party 1 and Party 2 and/or their local environments. Initial vid1 should have a continuity relationship with ongoing vid1. Initial vid2 should have a continuity relationship with ongoing vid2. Ongoing vid1′ should be displayed by Party 2 user interface module 325-2. Ongoing vid 2′ should be displayed by Party 1 user interface module 325-1. Ongoing vid1′ should have feedback through video content responsive to vid2. Ongoing vid2′ should have feedback through video content responsive to vid1. There should be randomness of video content including in initial vid1 and in initial vid2. In some embodiments Party 1 communication corruption detection module 335-1 may stop sending vid1 when initial vid1 or initial vid2′ is low entropy, which may occur with lens cover or incorrect camera settings. In some embodiments Party 2 communication corruption detection module 335-2 may stop sending vid2 when initial vid2 or initial vid1′ is low entropy, which may occur with lens cover or incorrect camera settings.

Party 1 continuity checking module 330-1 checks that initial vid2′ is continuous with ongoing vid2′. If the check fails Party 1 communication corruption detection module 335-1 determines that a communication corruption exists and Party 1 communication module 320-1 stops sending vid1 (540). Continuity checking may be performed in many ways. In some embodiments it may involve Party 1 continuity checking module 330-1 determining whether image features between initial vid2′ and ongoing vid2′ are consistent within a predetermined error threshold automatically. In some embodiments it may involve Party 1 user interface module 325-1 displaying initial vid2′ side-by-side, overlapped or differenced with ongoing vid2′ and prompting Party 1 for user input about consistency which influences Party 1 continuity checking module 330-1. Displayed images may exaggerate inconsistencies or highlight image regions based on the magnitude of automatically determined error. Supporting methods used by the continuity checking module 330-1 in some embodiments may include motion tracking of local features and object models for tracking objects.

Party 2 continuity checking module 330-2 checks that initial vid1′ is continuous with ongoing vid1′. If the check fails Party 2 communication corruption detection module 335-2 determines that a communication corruption exists and Party 2 communication module 320-2 stops sending vid2 (585). Continuity checking may be performed in many ways. In some embodiments it may involve Party 2 continuity checking module 330-2 determining whether image features between initial vid1 ‘ and ongoing vid1’ are consistent within a predetermined error threshold automatically. In some embodiments it may involve Party 2 user interface module 325-2 displaying initial vid1 ‘ side-by-side, overlapped or differenced with ongoing vid1’ and prompting Party 1 for input about consistency which influences Party 2 continuity checking module 330-2. Displayed images may exaggerate inconsistencies or highlight image regions based on the magnitude of automatically determined error. Supporting methods used by the continuity checking module 330-2 in some embodiments may include motion tracking of local features and object models for tracking objects.

Party 1 and Party 2 should check that received video and/or audio is not an impersonation and is not artificial (computer generated). Party 1 and Party 2 should check that the computer memory and video and/or audio device used to perform the embodiment is secure. Antivirus and firewall software may be useful to prevent an attacker gaining control over computing devices used in the method. Party 1 and Party 2 should check the integrity of any software used to implement the embodiment. Otherwise an attacker may be able to insert a backdoor or error in the software used to implement the method.

Private key data and session keys may be managed so that they do not exist before communications, are a function of random data, and are permanently erased after each call. Permanently erasing private key data and session keys at the conclusion of a call may prevent an attacker from recovering them in the future and using them to decrypt recorded communications. Video data buffers may also be permanently erased if the content is sensitive.

Party 1 and Party 2 may store X1 and X1′ data in call logs to allow comparison between logs made by Party 1 and Party 2 in a later call or in person. If an attacker does succeed, (for instance through undetected impersonation), but does not manipulate the logs, Party 1 and Party 2 may be able to determine what has occurred and possibly what data has been compromised.

As previously discussed if Party 1 or Party 2 detect a possible communication corruption they may stop sending video to the other party to indicate reliably to the other party the existence of a possible communication corruption. This may operate in an automated fashion, such that the call is dropped and a message reported when a potential communication corruption is detected. In some embodiments after detection of a possible communications corruption, there may be options to end communications or provide warning to prevent communication corruption success, or log communication corruption. In some embodiments the software implementing the embodiment includes instructions providing Party 1 and Party 2 with warnings and hints, or help, on ensuring security.

While only two parties are shown the embodiments may be used between multiple parties.

In some embodiments video may be other imagery with similar properties. A series of images or three dimensional video may be used in some embodiments.

Key elements of some embodiments related to FIG. 5 are an encoding that binds data to be authenticated to some audio and/or video data, a protocol that checks that audio and/or video data that may compromise the encoding is not released before the encoding was received by Party 2, and continuity checking that ensures audio and/or video data is valid.

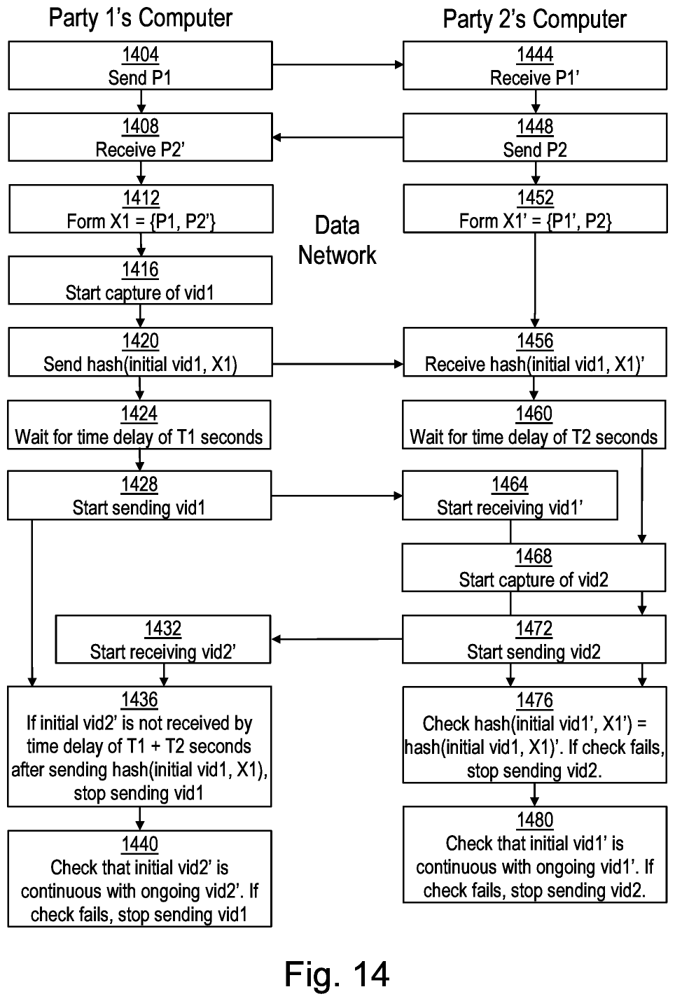

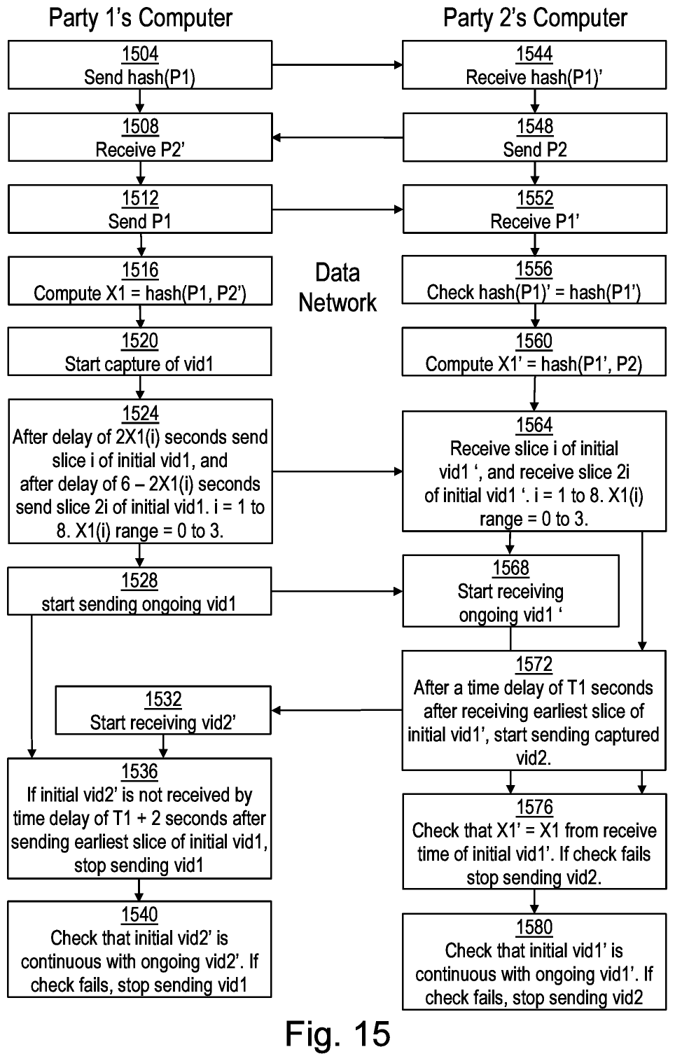

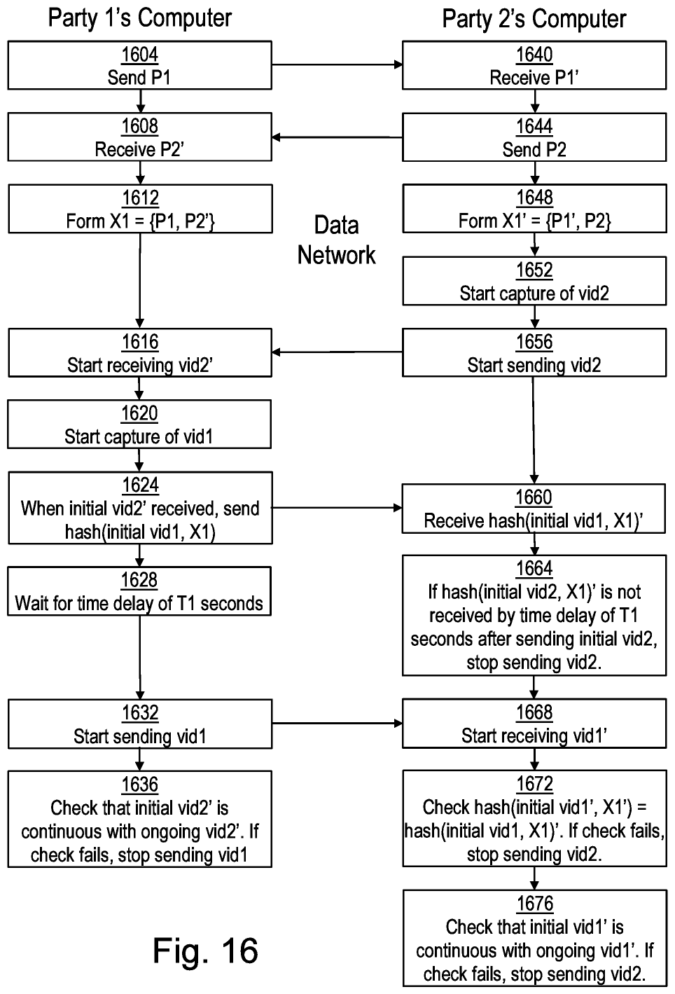

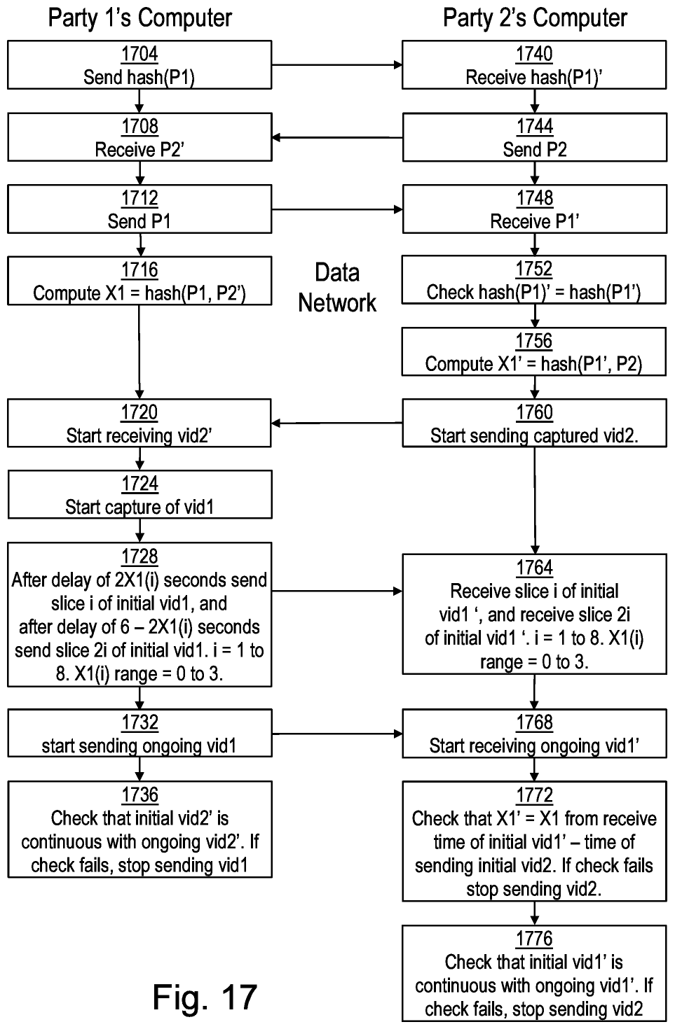

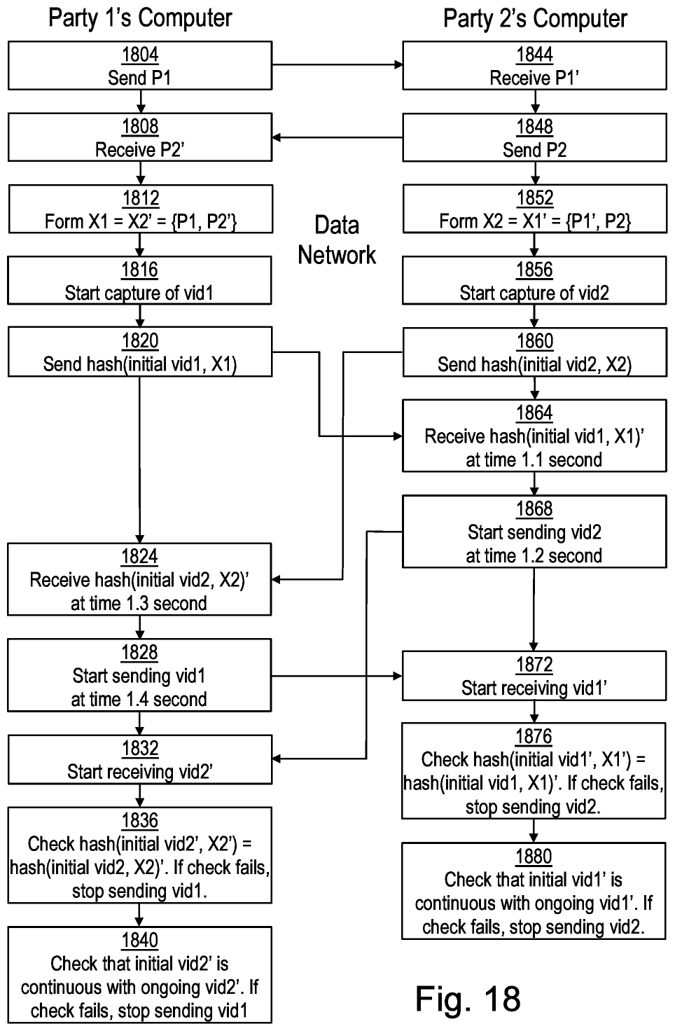

FIGS. 5 to 13 may be considered to describe a class of embodiments that use an audio and/or video acknowledgement in response to receiving encoded data. FIGS. 14 and 15 may be considered to describe a class of embodiments that use a delayed audio and/or video acknowledgement in response to receiving encoded data. FIGS. 16 and 17 may be considered to describe a class of embodiments that use encoded acknowledgment data in response to receiving audio and/or video data. FIGS. 18 to 20 may be considered to describe a set of embodiments that use an implicit rather than explicit audio and/or video acknowledgement in response to receiving encoded data.

Embodiments may be modified in various ways without departing from the spirit and scope of the concepts and applications of the embodiments described herein. For example, some such variations may relate to audio and/or video selection encoding of data to be authenticated, audio and/or video time delay encoding of data to be authenticated and/or hash/encryption encoding of data to be authenticated.

Audio and lower information content video such as black and white video may be sent prior to a call in some embodiments. When this is done it should not be possible for critical video and/or audio used in the embodiment to be validly substituted with video derived from the lower information content video, or from audio sent prior to a call.

Rather than using continuity relationships between initial video and ongoing video, some embodiments may use a continuity relationship between ongoing video and a concurrent higher information portion of video such as a higher resolution video frame or missing part of video frame. In some embodiments a continuity relationship between a missing time section of video and/or audio and surrounding ongoing video and/or audio may be used.

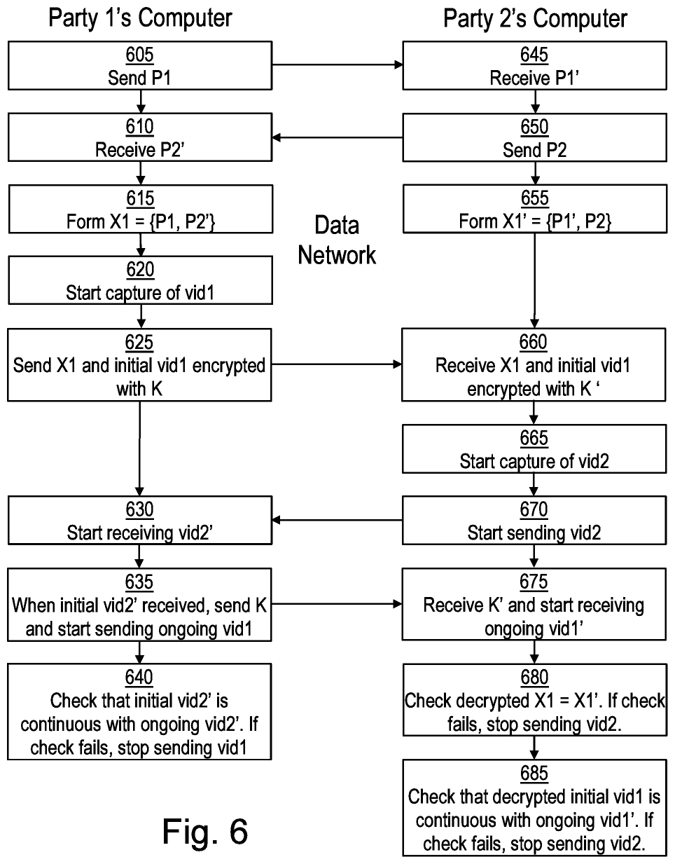

Embodiments related to FIG. 6 are similar to embodiments related to FIG. 5.

Party 1 call initialisation module 305-1 and Party 2 call initialisation module 305-2 initialise a data communication session. Party 1 communication module 320-1 sends P1 to Party 2 (605) and Party 2 communication module 320-2 receives P1′ purportedly from Party 1 (645). Party 2 communication module 320-2 sends P2 to Party 1 (650) and Party 1 communication module 320-1 receives P2′ purportedly from Party 2 (610). Party 1 call initialisation module 305-1 forms X1 data as the concatenation of P1 and P2′ (615) and Party 2 call initialisation module 305-2 forms X1′ data as the concatenation of P1′ and P2 (655).

Party 1 video and/or audio capture module 310-1 starts capture of Party 1 video vid1(620). Party 1 encoding module 315-1 creates a random AES encryption key K and uses it to encrypt the initial vid1 and X1 to produce encrypt(initial vid1, X1). Encryption methods other than AES may be used instead of AES. The encryption method should bind together the initial vid1 and X1. Therefore encryption methods that effectively use unrelated keys for encrypting initial vid1 and X1, such as one time pad encryption should not be used. The encryption method should also resist known-plaintext attack since X1 is not secret. Party 1 communication module 320-1 sends encrypt(initial vid1, X1) to Party 2 (625) and Party 2 communication module 320-2 receives encrypt(initial vid1, X1)′ purportedly from Party 1 (660). Party 2 video and/or audio capture module 310-2 starts capture of Party 2 video vid2 (665). Party 2 communication module 320-2 starts sending vid2 to Party 1 (670) and Party 1 communication module 320-1 starts receiving vid2′ purportedly from Party 2 (630). Once Party 1 communication module 320-1 receives some initial vid2′, such as a frame of vid2′, Party 1 communication module 320-1 sends K and starts sending ongoing vid1 to Party 2 (635). Party 2 communication module 320-2 receives K′ and starts receiving ongoing vid1′ purportedly from Party 1 (675).

Party 2 encoding module 315-2 decrypts encrypt(initial vid1, X1)′ and Party 2 communication corruption detection module 335-2 performs a check that decrypted X1=X1′. If the check fails Party 2 communication corruption detection module 335-2 determines that a communication corruption exists and Party 2 communication module 320-2 stops sending vid2 (680). The decryption function used by Party 2 and the associated encryption function used by Party 1 may be fixed. However the encryption function used by Party 1 may also be one of a variety of encryption functions. In this case Party 1 may send an index to the encryption function it used to Party 2, or alternatively Party 2 may by brute force perform the check with a variety of possible decryption functions until the check does not fail or all decryption functions have been tried.

Vid1 and vid2 may include imagery of the faces/body of Party 1 and Party 2 and/or their local environments. Initial vid1 should have a continuity relationship with ongoing vid1. Initial vid2 should have a continuity relationship with ongoing vid2. Ongoing vid1′ should be displayed by Party 2 user interface module 325-2. Ongoing vid 2′ should be displayed by Party 1 user interface module 325-1. Ongoing vid1′ should have feedback through video content responsive to vid2. Ongoing vid2′ should have feedback through video content responsive to vid1. There should be randomness of video content including in initial vid1 and in initial vid2. In some embodiments Party 1 communication corruption detection module 335-1 may stop sending vid1 when initial vid1 or initial vid2′ is low entropy, which may occur with lens cover or incorrect camera settings. In some embodiments Party 2 communication corruption detection module 335-2 may stop sending vid2 when initial vid2 or initial vid1′ is low entropy, which may occur with lens cover or incorrect camera settings.

Party 1 continuity checking module 330-1 checks that initial vid2′ is continuous with ongoing vid2′. If the check fails Party 1 communication corruption detection module 335-1 determines that a communication corruption exists and Party 1 communication module 320-1 stops sending vid1 (640). Continuity checking may be performed in many ways. In some embodiments it may involve Party 1 continuity checking module 330-1 determining whether image features between initial vid2′ and ongoing vid2′ are consistent within a predetermined error threshold automatically. In some embodiments it may involve Party 1 user interface module 325-1 displaying initial vid2′ side-by-side, overlapped or differenced with ongoing vid2′ and prompting Party 1 for user input about consistency which influences Party 1 continuity checking module 330-1. Displayed images may exaggerate inconsistencies or highlight image regions based on the magnitude of automatically determined error. Supporting methods used by the continuity checking module 330-1 in some embodiments may include motion tracking of local features and object models for tracking objects.

Party 2 continuity checking module 330-2 checks that decrypted initial vid1 is continuous with ongoing vid1′. If the check fails Party 2 communication corruption detection module 335-2 determines that a communication corruption exists and Party 2 communication module 320-2 stops sending vid2 (685). Continuity checking may be performed in many ways. In some embodiments it may involve Party 2 continuity checking module 330-2 determining whether image features between initial vid1′ and ongoing vid1′ are consistent within a predetermined error threshold automatically. In some embodiments it may involve Party 2 user interface module 325-2 displaying initial vid1′ side-by-side, overlapped or differenced with ongoing vid1′ and prompting Party 1 for input about consistency which influences Party 2 continuity checking module 330-2. Displayed images may exaggerate inconsistencies or highlight image regions based on the magnitude of automatically determined error. Supporting methods used by the continuity checking module 330-2 in some embodiments may include motion tracking of local features and object models for tracking objects.

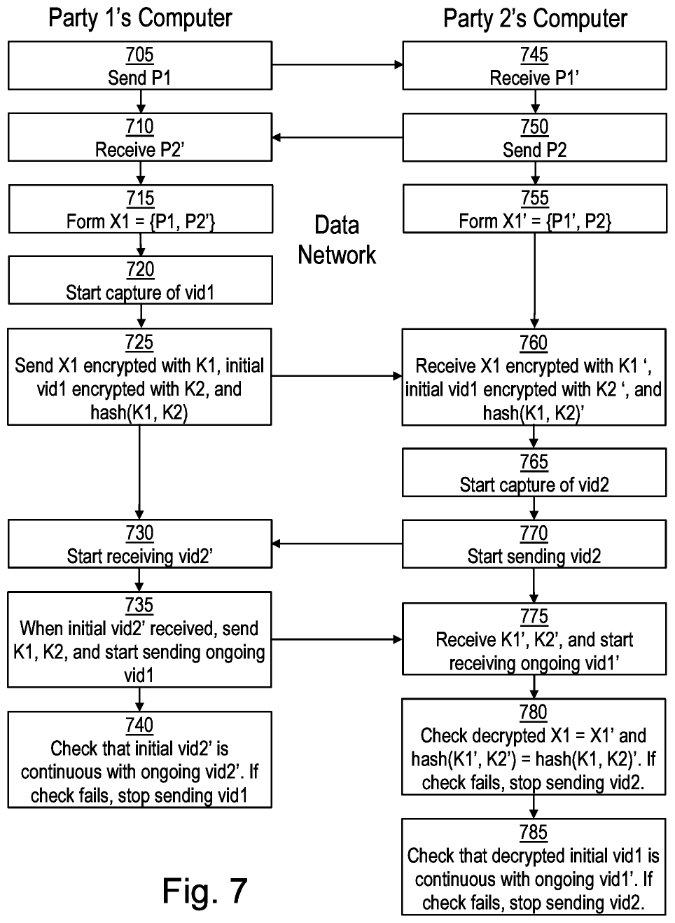

Embodiments related to FIG. 7 are similar to embodiments related to FIG. 5.

Party 1 call initialisation module 305-1 and Party 2 call initialisation module 305-2 initialise a data communication session. Party 1 communication module 320-1 sends P1 to Party 2 (705) and Party 2 communication module 320-2 receives P1′ purportedly from Party 1 (745). Party 2 communication module 320-2 sends P2 to Party 1 (750) and Party 1 communication module 320-1 receives P2′ purportedly from Party 2 (710). Party 1 call initialisation module 305-1 forms X1 data as the concatenation of P1 and P2′ (715) and Party 2 call initialisation module 305-2 forms X1′ data as the concatenation of P1′ and P2 (755).

Party 1 video and/or audio capture module 310-1 starts capture of Party 1 video vid1 (720). Party 1 encoding module 315-1 creates two random AES encryption keys K1, K2 and uses K1 to encrypt X1 to produce encrypt(X1) and K2 to encrypt the initial vid1 to produce encrypt(initial vid1). Encryption methods other than AES may be used instead of AES. The encryption method used to encrypt X1 should resist known plain text attack since X1 is not secret. Additionally Party 1 encoding module 315-1 applies a hash function to the two encryption keys to produce hash(K1,K2). The hash function could be a cryptographic hash function or other function that binds together K1 and K2 but does not reveal K1 or K2. Party 1 communication module 320-1 sends encrypt(X1), encrypt(initial vid1), and hash(K1, K2) to Party 2 (725) and Party 2 communication module 320-2 receives encrypt(X1)′, encrypt(initial vid1)′, and hash(K1, K2)′ purportedly from Party 1 (760). Party 2 video and/or audio capture module 310-2 starts capture of Party 2 video vid2 (765). Party 2 communication module 320-2 starts sending vid2 to Party 1 (770) and Party 1 communication module 320-1 starts receiving vid2′ purportedly from Party 2 (730). Once Party 1 communication module 320-1 receives some initial vid2′, such as a frame of vid2′, Party 1 communication module 320-1 sends K1, K2 and starts sending ongoing vid1 to Party 2 (735). Party 2 communication module 320-2 receives K1′, K2′ and starts receiving ongoing vid1′ purportedly from Party 1 (775).

Party 2 encoding module 315-2 decrypts encrypt(X1)′ using K1′, and Party 2 communication corruption detection module 335-2 performs a check that decrypted X1=X1′ and that that hash′ (K1′, K2′)=hash(K1, K2)′. If the check fails Party 2 communication corruption detection module 335-2 determines that a communication corruption exists and Party 2 communication module 320-2 stops sending vid2 (780). Hash′ used by Party 2 and the hash function used by Party 1 may be a fixed hash function. However hash′ used by Party 2 and the hash function used by Party 1 may also be one of a variety of hash functions. In this case Party 1 may send an index to the hash function it used to Party 2, or alternatively Party 2 may by brute force perform the check with a variety of possible hash functions until the check does not fail or all hash functions have been tried. The decryption function used by Party 2 and the associated encryption function used by Party 1 may be fixed. However the encryption function used by Party 1 may also be one of a variety of encryption functions. In this case Party 1 may send an index to the encryption function it used to Party 2, or alternatively Party 2 may by brute force perform the check with a variety of possible decryption functions until the check does not fail or all decryption functions have been tried.

Vid1 and vid2 may include imagery of the faces/body of Party 1 and Party 2 and/or their local environments. Initial vid1 should have a continuity relationship with ongoing vid1. Initial vid2 should have a continuity relationship with ongoing vid2. Ongoing vid1′ should be displayed by Party 2 user interface module 325-2. Ongoing vid 2′ should be displayed by Party 1 user interface module 325-1. Ongoing vid1′ should have feedback through video content responsive to vid2. Ongoing vid2′ should have feedback through video content responsive to vid1. There should be randomness of video content including in initial vid1 and in initial vid2. In some embodiments Party 1 communication corruption detection module 335-1 may stop sending vid1 when initial vid1 or initial vid2′ is low entropy, which may occur with lens cover or incorrect camera settings. In some embodiments Party 2 communication corruption detection module 335-2 may stop sending vid2 when initial vid2 or initial vid1′ is low entropy, which may occur with lens cover or incorrect camera settings.

Party 1 continuity checking module 330-1 checks that initial vid2′ is continuous with ongoing vid2′. If the check fails Party 1 communication corruption detection module 335-1 determines that a communication corruption exists and Party 1 communication module 320-1 stops sending vid1 (740). Continuity checking may be performed in many ways. In some embodiments it may involve Party 1 continuity checking module 330-1 determining whether image features between initial vid2′ and ongoing vid2′ are consistent within a predetermined error threshold automatically. In some embodiments it may involve Party 1 user interface module 325-1 displaying initial vid2′ side-by-side, overlapped or differenced with ongoing vid2′ and prompting Party 1 for user input about consistency which influences Party 1 continuity checking module 330-1. Displayed images may exaggerate inconsistencies or highlight image regions based on the magnitude of automatically determined error. Supporting methods used by the continuity checking module 330-1 in some embodiments may include motion tracking of local features and object models for tracking objects.

Party 2 encoding module 315-2 decrypts encrypt(initial vid1)′ using K2′. Party 2 continuity checking module 330-2 checks that decrypted initial vid1 is continuous with ongoing vid1′. If the check fails Party 2 communication corruption detection module 335-2 determines that a communication corruption exists and Party 2 communication module 320-2 stops sending vid2 (785). Continuity checking may be performed in many ways. In some embodiments it may involve Party 2 continuity checking module 330-2 determining whether image features between initial vid1′ and ongoing vid1′ are consistent within a predetermined error threshold automatically. In some embodiments it may involve Party 2 user interface module 325-2 displaying initial vid1′ side-by-side, overlapped or differenced with ongoing vid1′ and prompting Party 1 for input about consistency which influences Party 2 continuity checking module 330-2. Displayed images may exaggerate inconsistencies or highlight image regions based on the magnitude of automatically determined error. Supporting methods used by the continuity checking module 330-2 in some embodiments may include motion tracking of local features and object models for tracking objects. The decryption function used by Party 2 and the associated encryption function used by Party 1 may be fixed. However the encryption function used by Party 1 may also be one of a variety of encryption functions. In this case Party 1 may send an index to the encryption function it used to Party 2, or alternatively Party 2 may by brute force perform the check with a variety of possible decryption functions until the check does not fail or all decryption functions have been tried.

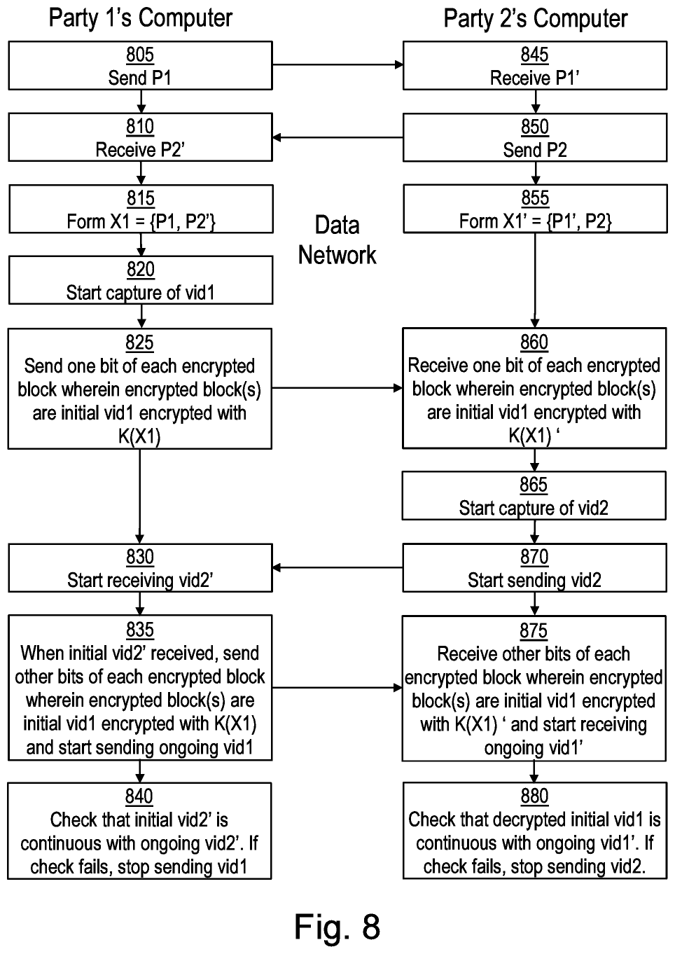

Embodiments related to FIG. 8 are similar to embodiments related to FIG. 5.

Party 1 call initialisation module 305-1 and Party 2 call initialisation module 305-2 initialise a data communication session. Party 1 communication module 320-1 sends P1 to Party 2 (805) and Party 2 communication module 320-2 receives P1′ purportedly from Party 1 (845). Party 2 communication module 320-2 sends P2 to Party 1 (850) and Party 1 communication module 320-1 receives P2′ purportedly from Party 2 (810). Party 1 call initialisation module 305-1 forms X1 data as the concatenation of P1 and P2′ (815) and Party 2 call initialisation module 305-2 forms X1′ data as the concatenation of P1′ and P2 (855).

Party 1 video and/or audio capture module 310-1 starts capture of Party 1 video vid1 (820). Party 1 encoding module 315-1 creates an encryption of the initial vid1, using the shared session key which is a function of X1, and a block cipher such as AES to produce encrypt1(initial vid1) and encrypt2(initial vid1), where encrypt1(initial vid1) is one bit of each block of cipher-text and encrypt2(initial vid1) is the other bits of each block of cipher-text. Party 1 communication module 320-1 sends encrypt1(initial vid1, X1) to Party 2 (825) and Party 2 communication module 320-2 receives encrypt1(initial vid1, X1)′ purportedly from Party 1 (860). Party 2 video and/or audio capture module 310-2 starts capture of Party 2 video vid2 (865). Party 2 communication module 320-2 starts sending vid2 to Party 1 (870) and Party 1 communication module 320-1 starts receiving vid2′ purportedly from Party 2 (830). Once Party 1 communication module 320-1 receives some initial vid2′, such as a frame of vid2′, Party 1 communication module 320-1 sends encrypt2(initial vid1) and starts sending ongoing vid1 to Party 2 (835). Party 2 communication module 320-2 receives encrypt2(initial vid1)′ and starts receiving ongoing vid1′ purportedly from Party 1 (875).

Vid1 and vid2 may include imagery of the faces/body of Party 1 and Party 2 and/or their local environments. Initial vid1 should have a continuity relationship with ongoing vid1. Initial vid2 should have a continuity relationship with ongoing vid2. Ongoing vid1′ should be displayed by Party 2 user interface module 325-2. Ongoing vid 2′ should be displayed by Party 1 user interface module 325-1. Ongoing vid1′ should have feedback through video content responsive to vid2. Ongoing vid2′ should have feedback through video content responsive to vid1. There should be randomness of video content including in initial vid1 and in initial vid2. In some embodiments Party 1 communication corruption detection module 335-1 may stop sending vid1 when initial vid1 or initial vid2′ is low entropy, which may occur with lens cover or incorrect camera settings. In some embodiments Party 2 communication corruption detection module 335-2 may stop sending vid2 when initial vid2 or initial vid1′ is low entropy, which may occur with lens cover or incorrect camera settings.

Party 1 continuity checking module 330-1 checks that initial vid2′ is continuous with ongoing vid2′. If the check fails Party 1 communication corruption detection module 335-1 determines that a communication corruption exists and Party 1 communication module 320-1 stops sending vid1 (840). Continuity checking may be performed in many ways. In some embodiments it may involve Party 1 continuity checking module 330-1 determining whether image features between initial vid2′ and ongoing vid2′ are consistent within a predetermined error threshold automatically. In some embodiments it may involve Party 1 user interface module 325-1 displaying initial vid2′ side-by-side, overlapped or differenced with ongoing vid2′ and prompting Party 1 for user input about consistency which influences Party 1 continuity checking module 330-1. Displayed images may exaggerate inconsistencies or highlight image regions based on the magnitude of automatically determined error. Supporting methods used by the continuity checking module 330-1 in some embodiments may include motion tracking of local features and object models for tracking objects.

Party 2 encoding module 315-2 uses encrypt1(initial vid1)′, encrypt2(initial vid1)′ and X1′ to produce decrypted initial vid1. Party 2 continuity checking module 330-2 checks that decrypted initial vid1 is continuous with ongoing vid1′. If the check fails Party 2 communication corruption detection module 335-2 determines that a communication corruption exists and Party 2 communication module 320-2 stops sending vid2 (880). Continuity checking may be performed in many ways. In some embodiments it may involve Party 2 continuity checking module 330-2 determining whether image features between initial vid1′ and ongoing vid1′ are consistent within a predetermined error threshold automatically. In some embodiments it may involve Party 2 user interface module 325-2 displaying initial vid1′ side-by-side, overlapped or differenced with ongoing vid1′ and prompting Party 1 for input about consistency which influences Party 2 continuity checking module 330-2. Displayed images may exaggerate inconsistencies or highlight image regions based on the magnitude of automatically determined error. Supporting methods used by the continuity checking module 330-2 in some embodiments may include motion tracking of local features and object models for tracking objects.

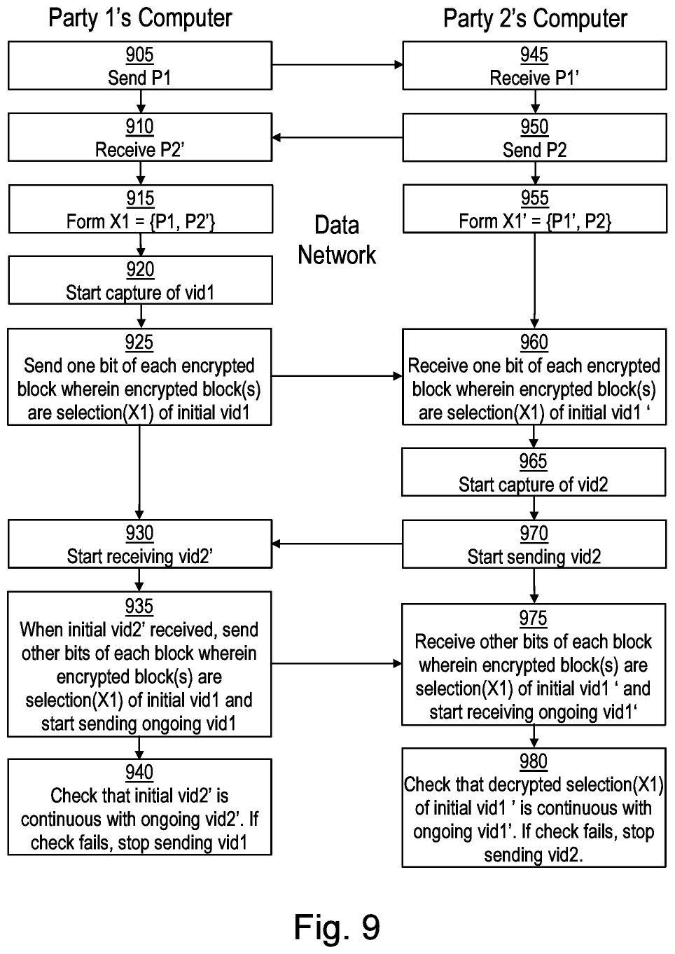

Embodiments related to FIG. 9 are similar to embodiments related to FIG. 5.

Party 1 call initialisation module 305-1 and Party 2 call initialisation module 305-2 initialise a data communication session. Party 1 communication module 320-1 sends P1 to Party 2 (905) and Party 2 communication module 320-2 receives P1′ purportedly from Party 1 (945). Party 2 communication module 320-2 sends P2 to Party 1 (950) and Party 1 communication module 320-1 receives P2′ purportedly from Party 2 (910). Party 1 call initialisation module 305-1 forms X1 data as the concatenation of P1 and P2′ (915) and Party 2 call initialisation module 305-2 forms X1′ data as the concatenation of P1′ and P2 (955).

Party 1 video and/or audio capture module 310-1 starts capture of Party 1 video vid1 (920). Party 1 encoding module 315-1 selects a selection mask based on X1 and selects pixels or other image data corresponding to the selection mask from the initial vid1 to create selection(X1) of initial vid1. Party 1 encoding module 315-1 creates an encryption of a selection(X1) of initial vid1 using a block cipher such as AES and a key to produce encrypt1(selection(X1) of initial vid1) and encrypt2(selection(X1) of initial vid1), where encrypt1(selection(X1) of initial vid1) is one bit of each block of cipher-text and encrypt2(selection(X1) of initial vid1) is the other bits of each block of cipher-text. Party 1 communication module 320-1 sends encrypt1(initial vid1, X1) to Party 2 (925) and Party 2 communication module 320-2 receives encrypt1(initial vid1, X1)′ purportedly from Party 1 (960). Party 2 video and/or audio capture module 310-2 starts capture of Party 2 video vid2 (965). Party 2 communication module 320-2 starts sending vid2 to Party 1 (970) and Party 1 communication module 320-1 starts receiving vid2′ purportedly from Party 2 (930). Once Party 1 communication module 320-1 receives some initial vid2′, such as a frame of vid2′, Party 1 communication module 320-1 sends encrypt2(initial vid1) and starts sending ongoing vid1 to Party 2 (935). Party 2 communication module 320-2 receives encrypt2(initial vid1)′ and starts receiving ongoing vid1′ purportedly from Party 1 (975).

Vid1 and vid2 may include imagery of the faces/body of Party 1 and Party 2 and/or their local environments. Initial vid1 should have a continuity relationship with ongoing vid1. Initial vid2 should have a continuity relationship with ongoing vid2. Ongoing vid1′ should be displayed by Party 2 user interface module 325-2. Ongoing vid 2′ should be displayed by Party 1 user interface module 325-1. Ongoing vid1′ should have feedback through video content responsive to vid2. Ongoing vid2′ should have feedback through video content responsive to vid1. There should be randomness of video content including in initial vid1 and in initial vid2. In some embodiments Party 1 communication corruption detection module 335-1 may stop sending vid1 when initial vid1 or initial vid2′ is low entropy, which may occur with lens cover or incorrect camera settings. In some embodiments Party 2 communication corruption detection module 335-2 may stop sending vid2 when initial vid2 or initial vid1′ is low entropy, which may occur with lens cover or incorrect camera settings.

Party 1 continuity checking module 330-1 checks that initial vid2′ is continuous with ongoing vid2′. If the check fails Party 1 communication corruption detection module 335-1 determines that a communication corruption exists and Party 1 communication module 320-1 stops sending vid1 (940). Continuity checking may be performed in many ways. In some embodiments it may involve Party 1 continuity checking module 330-1 determining whether image features between initial vid2′ and ongoing vid2′ are consistent within a predetermined error threshold automatically. In some embodiments it may involve Party 1 user interface module 325-1 displaying initial vid2′ side-by-side, overlapped or differenced with ongoing vid2′ and prompting Party 1 for user input about consistency which influences Party 1 continuity checking module 330-1. Displayed images may exaggerate inconsistencies or highlight image regions based on the magnitude of automatically determined error. Supporting methods used by the continuity checking module 330-1 in some embodiments may include motion tracking of local features and object models for tracking objects.

Party 2 encoding module 315-2 uses encrypt1(selection(X1) of initial vid1)′, encrypt2(selection(X1) of initial vid1)′ and a key, to produce decrypted selection(X1) of initial vid1. Party 2 encoding module 315-2 identifies the selection mask related to X1′. Party 2 continuity checking module 330-2 checks that decrypted selection(X1) of initial vid1 is continuous with ongoing vid 1 ‘ using the identified selection mask related to X1’. If the check fails Party 2 communication corruption detection module 335-2 determines that a communication corruption exists and Party 2 communication module 320-2 stops sending vid2 (980). Continuity checking may be performed in many ways. In some embodiments it may involve Party 2 continuity checking module 330-2 determining whether image features between decrypted selection(X1) of initial vid1 and ongoing vid1′ are consistent within a predetermined error threshold automatically. In some embodiments it may involve Party 2 user interface module 325-2 displaying decrypted selection(X1) of initial vid1 side-by-side, overlapped or differenced with ongoing vid1′ and prompting Party 1 for input about consistency which influences Party 2 continuity checking module 330-2. Displayed images may exaggerate inconsistencies or highlight image regions based on the magnitude of automatically determined error. Supporting methods used by the continuity checking module 330-2 in some embodiments may include motion tracking of local features and object models for tracking objects.

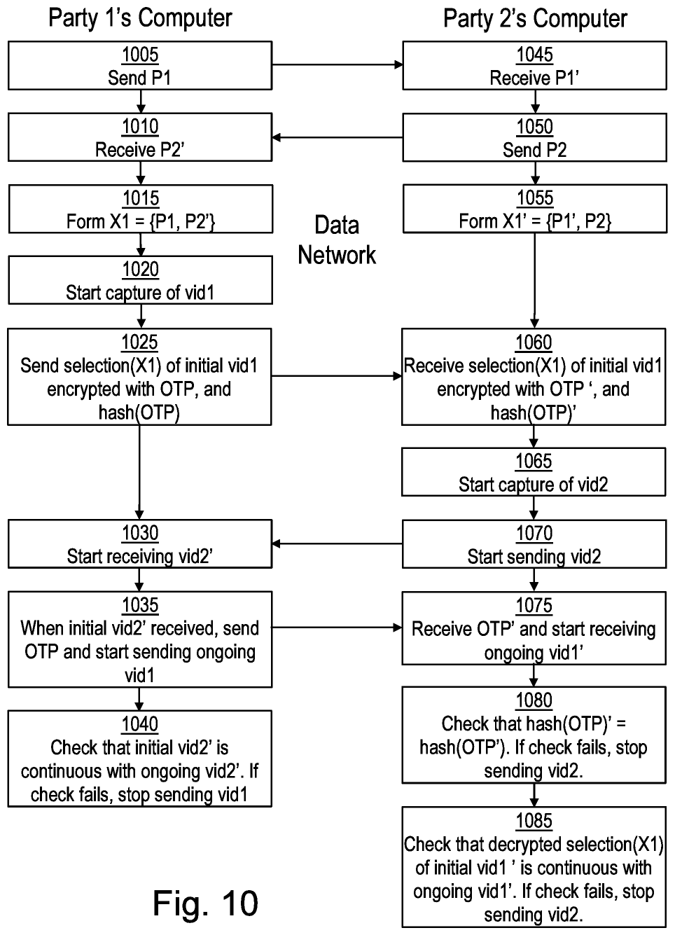

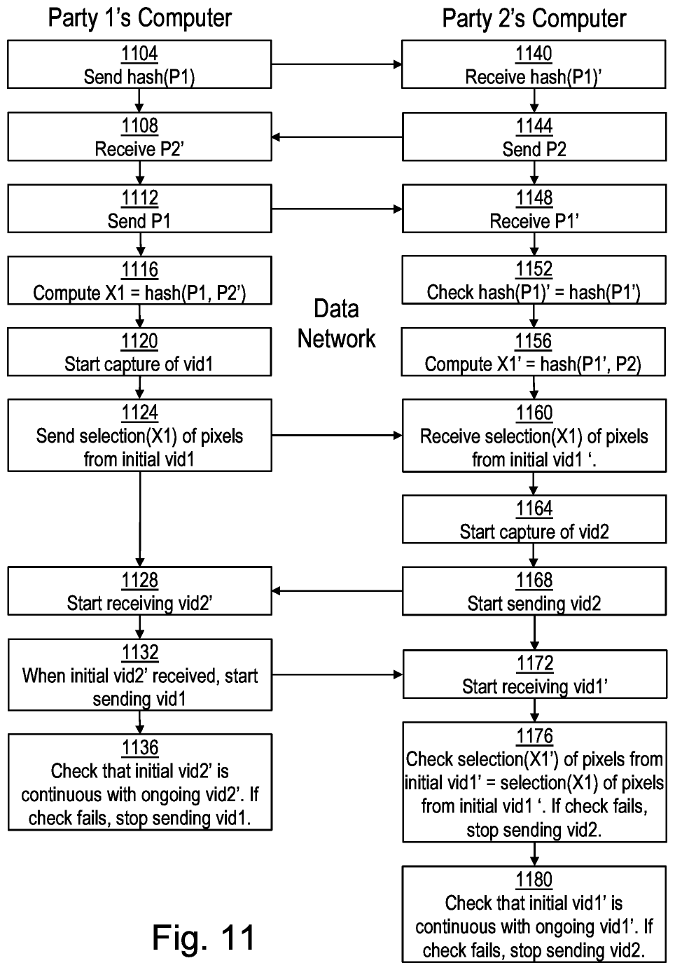

Embodiments related to FIG. 10 are similar to embodiments related to FIG. 5.

Party 1 call initialisation module 305-1 and Party 2 call initialisation module 305-2 initialise a data communication session. Party 1 communication module 320-1 sends P1 to Party 2 (1005) and Party 2 communication module 320-2 receives P1′ purportedly from Party 1 (1045). Party 2 communication module 320-2 sends P2 to Party 1 (1050) and Party 1 communication module 320-1 receives P2′ purportedly from Party 2 (1010). Party 1 call initialisation module 305-1 forms X1 data as the concatenation of P1 and P2′ (1015) and Party 2 call initialisation module 305-2 forms X1′ data as the concatenation of P1′ and P2 (1055).

Party 1 video and/or audio capture module 310-1 starts capture of Party 1 video vid1 (1020). Party 1 encoding module 315-1 selects a selection mask based on X1 and selects pixels or other image data corresponding to the selection mask from the initial vid1 to create selection(X1) of initial vid1. Party 1 encoding module 315-1 creates an one time pad encryption of a selection(X1) of initial vid1 using a new randomly generated one time pad key OTP to produce OTP(selection(X1) of initial vid1). Additionally Party 1 encoding module 315-1 applies a hash function to OTP to produce hash(OTP). Party 1 communication module 320-1 sends OTP(selection(X1) of initial vid1) and hash(OTP) to Party 2 (1025) and Party 2 communication module 320-2 receives OTP(selection(X1) of initial vid1)′ and hash(OTP)′ purportedly from Party 1 (1060). Party 2 video and/or audio capture module 310-2 starts capture of Party 2 video vid2 (1065). Party 2 communication module 320-2 starts sending vid2 to Party 1 (1070) and Party 1 communication module 320-1 starts receiving vid2′ purportedly from Party 2 (1030). Once Party 1 communication module 320-1 receives some initial vid2′, such as a frame of vid2′, Party 1 communication module 320-1 sends OTP and starts sending ongoing vid1 to Party 2 (1035). Party 2 communication module 320-2 receives OTP′ and starts receiving ongoing vid1′ purportedly from Party 1 (1075).

Party 2 communication corruption detection module 335-2 performs a check that hash′ (OTP′)=hash(OTP)′. If the check fails Party 2 communication corruption detection module 335-2 determines that a communication corruption exists and Party 2 communication module 320-2 stops sending vid2 (1080). Hash′ used by Party 2 and the hash function used by Party 1 may be a fixed hash function. However hash′ used by Party 2 and the hash function used by Party 1 may also be one of a variety of hash functions. In this case Party 1 may send an index to the hash function it used to Party 2, or alternatively Party 2 may by brute force perform the check with a variety of possible hash functions until the check does not fail or all hash functions have been tried.

Vid1 and vid2 may include imagery of the faces/body of Party 1 and Party 2 and/or their local environments. Initial vid1 should have a continuity relationship with ongoing vid1. Initial vid2 should have a continuity relationship with ongoing vid2. Ongoing vid1′ should be displayed by Party 2 user interface module 325-2. Ongoing vid 2′ should be displayed by Party 1 user interface module 325-1. Ongoing vid1′ should have feedback through video content responsive to vid2. Ongoing vid2′ should have feedback through video content responsive to vid1. There should be randomness of video content including in initial vid1 and in initial vid2. In some embodiments Party 1 communication corruption detection module 335-1 may stop sending vid1 when initial vid1 or initial vid2′ is low entropy, which may occur with lens cover or incorrect camera settings. In some embodiments Party 2 communication corruption detection module 335-2 may stop sending vid2 when initial vid2 or initial vid1′ is low entropy, which may occur with lens cover or incorrect camera settings.

Party 1 continuity checking module 330-1 checks that initial vid2′ is continuous with ongoing vid2′. If the check fails Party 1 communication corruption detection module 335-1 determines that a communication corruption exists and Party 1 communication module 320-1 stops sending vid1 (1040). Continuity checking may be performed in many ways. In some embodiments it may involve Party 1 continuity checking module 330-1 determining whether image features between initial vid2′ and ongoing vid2′ are consistent within a predetermined error threshold automatically. In some embodiments it may involve Party 1 user interface module 325-1 displaying initial vid2′ side-by-side, overlapped or differenced with ongoing vid2′ and prompting Party 1 for user input about consistency which influences Party 1 continuity checking module 330-1. Displayed images may exaggerate inconsistencies or highlight image regions based on the magnitude of automatically determined error. Supporting methods used by the continuity checking module 330-1 in some embodiments may include motion tracking of local features and object models for tracking objects.

Party 2 encoding module 315-2 uses OTP(selection(X1) of initial vid1)′, and OTP′ to produce decrypted selection(X1) of initial vid1. Party 2 encoding module 315-2 identifies the selection mask related to X1′. Party 2 continuity checking module 330-2 checks that decrypted selection(X1) of initial vid1 is continuous with ongoing vid1′ using the identified selection mask related to X1′. If the check fails Party 2 communication corruption detection module 335-2 determines that a communication corruption exists and Party 2 communication module 320-2 stops sending vid2 (1085). Continuity checking may be performed in many ways. In some embodiments it may involve Party 2 continuity checking module 330-2 determining whether image features between decrypted selection(X1) of initial vid1 and ongoing vid1′ are consistent within a predetermined error threshold automatically. In some embodiments it may involve Party 2 user interface module 325-2 displaying decrypted selection(X1) of initial vid1 side-by-side, overlapped or differenced with ongoing vid1′ and prompting Party 1 for input about consistency which influences Party 2 continuity checking module 330-2. Displayed images may exaggerate inconsistencies or highlight image regions based on the magnitude of automatically determined error. Supporting methods used by the continuity checking module 330-2 in some embodiments may include motion tracking of local features and object models for tracking objects.

Embodiments related to FIG. 11 are similar to embodiments related to FIG. 5.

Party 1 call initialisation module 305-1 and Party 2 call initialisation module 305-2 initialise a data communication session. Party 1 call initialisation module 305-1 applies a hash function to previously undisclosed P1 to produce hash(P1). The hash function may be a cryptographic hash function. Party 1 communication module 320-1 sends hash(P1) to Party 2 (1104) and Party 2 communication module 320-2 receives hash(P1)′ purportedly from Party 1 (1140). Party 2 communication module 320-2 sends previously undisclosed P2 to Party 1 (1144) and Party 1 communication module 320-1 receives P2′ purportedly from Party 2 (1108). Party 1 communication module 320-1 sends P1 to Party 2 (1112) and Party 2 communication module 320-2 receives P1′ purportedly from Party 1 (1148). Party 2 call initialisation module 305-2 applies the same hash function purportedly used to create hash(P1)′ to P1′ to produce hash′ (P1). Party 2 communication corruption detection module 335-2 performs a check (1152) that hash′ (P1′)=hash(P1)′. If the check fails Party 2 communication corruption detection module 335-2 determines that a communication corruption exists and terminates the call. Party 1 call initialisation module 305-1 forms 16 bit X1 data by applying a hash function to the concatenation of P1 and P2′ (1116) and Party 2 call initialisation module 305-2 forms 16 bit X1′ data by applying the same hash function to the concatenation of P1′ and P2 (1156). The X1 and X1′ data may be less than 16 bits or longer than 16 bits in some embodiments.

Party 1 video and/or audio capture module 310-1 starts capture of Party 1 video vid1 (1120). Party 1 encoding module 315-1 selects a selection mask based on X1 and selects pixels or other image data corresponding to the selection mask from the initial vid1 to create selection(X1) of initial vid1. The selection mask may be pixels corresponding to 1 out of 65,536 thin line scribble patterns formed by 16 different thin line scribble patterns in each quadrant of the initial vid1. Other sets of selection masks are possible. Party 1 communication module 320-1 sends selection(X1) of initial vid1 to Party 2 (1124) and Party 2 communication module 320-2 receives selection(X1) of initial vid1′ (1160). Party 2 video and/or audio capture module 310-2 starts capture of Party 2 video vid2 (1164). Party 2 communication module 320-2 starts sending vid2 to Party 1 (1168) and Party 1 communication module 320-1 starts receiving vid2′ purportedly from Party 2 (1128). Once Party 1 communication module 320-1 receives some initial vid2′, such as a frame of vid2′, Party 1 communication module 320-1 initial vid1 and starts sending ongoing vid1 to Party 2 (1132). Party 2 communication module 320-2 receives initial vid1′ and starts receiving ongoing vid1′ purportedly from Party 1 (1172).

Party 2 encoding module 315-2 identifies the selection mask related to X1′ and selects pixels or other image data corresponding to the selection mask from the initial vid1′ to create selection′ (X1′) of initial vid1′. Party 2 communication corruption detection module 335-2 performs a check that selection′ (X1′) of initial vid1′=selection(X1) of initial vid1′. If the check fails Party 2 communication corruption detection module 335-2 determines that a communication corruption exists and Party 2 communication module 320-2 stops sending vid2 (1176). The set of selection masks used by Party 2 and the set of selection masks used by Party 1 may be a fixed set of selection masks. However the set of selection masks used by Party 2 and the set of selection masks used by Party 1 may also be one of a variety of sets of selection masks. In this case Party 1 may send an index to the set of selection masks it used to Party 2, or alternatively Party 2 may by brute force perform the check with a variety of sets of selection masks until the check does not fail or all sets of selection masks have been tried.

Vid1 and vid2 may include imagery of the faces/body of Party 1 and Party 2 and/or their local environments. Initial vid1 should have a continuity relationship with ongoing vid1. Initial vid2 should have a continuity relationship with ongoing vid2. Ongoing vid1′ should be displayed by Party 2 user interface module 325-2. Ongoing vid 2′ should be displayed by Party 1 user interface module 325-1. Ongoing vid1′ should have feedback through video content responsive to vid2. Ongoing vid2′ should have feedback through video content responsive to vid1. There should be randomness of video content including in initial vid1 and in initial vid2. In some embodiments Party 1 communication corruption detection module 335-1 may stop sending vid1 when initial vid1 or initial vid2′ is low entropy, which may occur with lens cover or incorrect camera settings. In some embodiments Party 2 communication corruption detection module 335-2 may stop sending vid2 when initial vid2 or initial vid1′ is low entropy, which may occur with lens cover or incorrect camera settings.

Party 1 continuity checking module 330-1 checks that initial vid2′ is continuous with ongoing vid2′. If the check fails Party 1 communication corruption detection module 335-1 determines that a communication corruption exists and Party 1 communication module 320-1 stops sending vid1 (1136). Continuity checking may be performed in many ways. In some embodiments it may involve Party 1 continuity checking module 330-1 determining whether image features between initial vid2′ and ongoing vid2′ are consistent within a predetermined error threshold automatically. In some embodiments it may involve Party 1 user interface module 325-1 displaying initial vid2′ side-by-side, overlapped or differenced with ongoing vid2′ and prompting Party 1 for user input about consistency which influences Party 1 continuity checking module 330-1. Displayed images may exaggerate inconsistencies or highlight image regions based on the magnitude of automatically determined error. Supporting methods used by the continuity checking module 330-1 in some embodiments may include motion tracking of local features and object models for tracking objects.

Party 2 continuity checking module 330-2 checks that initial vid1′ is continuous with ongoing vid1′. If the check fails Party 2 communication corruption detection module 335-2 determines that a communication corruption exists and Party 2 communication module 320-2 stops sending vid2 (1180). Continuity checking may be performed in many ways. In some embodiments it may involve Party 2 continuity checking module 330-2 determining whether image features between initial vid1′ and ongoing vid1′ are consistent within a predetermined error threshold automatically. In some embodiments it may involve Party 2 user interface module 325-2 displaying initial vid1′ side-by-side, overlapped or differenced with ongoing vid1′ and prompting Party 1 for input about consistency which influences Party 2 continuity checking module 330-2. Displayed images may exaggerate inconsistencies or highlight image regions based on the magnitude of automatically determined error. Supporting methods used by the continuity checking module 330-2 in some embodiments may include motion tracking of local features and object models for tracking objects.

Initial vid1 does not need to be sent to Party 2 in addition to selection(X1) of initial vid1. The discussion of embodiments related to FIG. 9 and FIG. 10 describes how a continuity check can be performed without sending initial vid1 in addition to selection(X1) of initial vid1. Embodiments related to FIG. 11 may operate similarly.

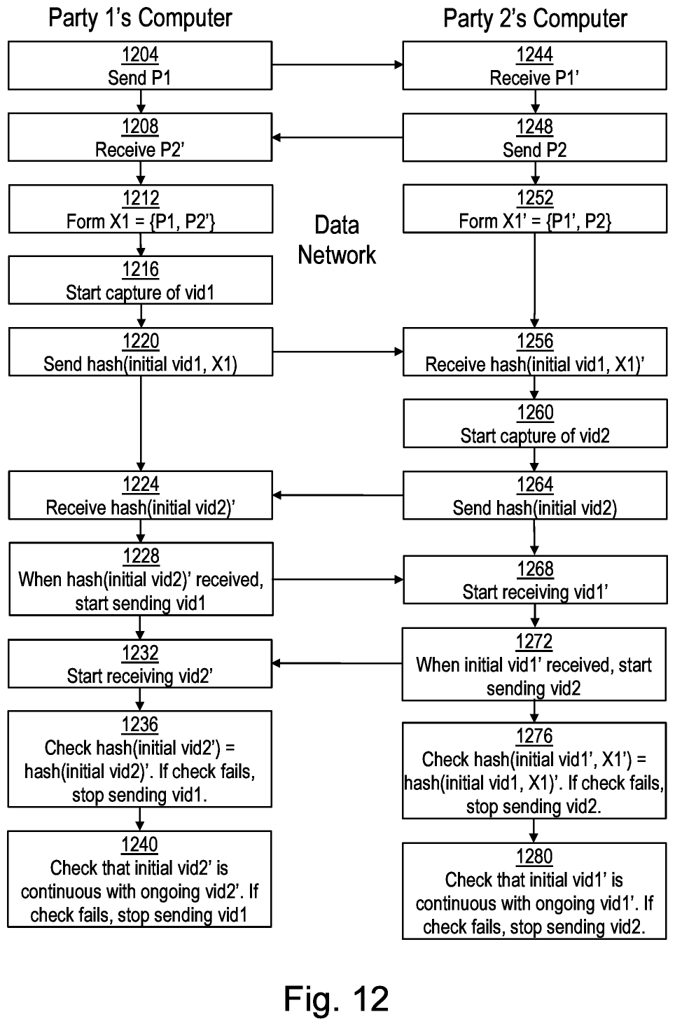

Embodiments related to FIG. 12 are similar to embodiments related to FIG. 5.

Party 1 call initialisation module 305-1 and Party 2 call initialisation module 305-2 initialise a data communication session. Party 1 communication module 320-1 sends P1 to Party 2 (1204) and Party 2 communication module 320-2 receives P1′ purportedly from Party 1 (1244). Party 2 communication module 320-2 sends P2 to Party 1 (1248) and Party 1 communication module 320-1 receives P2′ purportedly from Party 2 (1208). Party 1 call initialisation module 305-1 forms X1 data as the concatenation of P1 and P2′ (1212) and Party 2 call initialisation module 305-2 forms X1′ data as the concatenation of P1′ and P2 (1252).

Party 1 video and/or audio capture module 310-1 starts capture of Party 1 video vid1 (1216). Party 1 encoding module 315-1 applies a hash function to the initial vid1 and to X1 to produce a hash value hash(initial vid1, X1). The hash function may be a cryptographic hash function or other function that binds together initial vid1 and X1 without revealing initial vid1. Party 1 communication module 320-1 sends hash(initial vid1, X1) to Party 2 (1220) and Party 2 communication module 320-2 receives hash(initial vid1, X1)′ purportedly from Party 1 (1256). Party 2 video and/or audio capture module 310-2 starts capture of Party 2 video vid2 (1260). Party 2 encoding module 315-2 applies a hash function to the initial vid2 to produce hash(initial vid2). This hash may include other data such as X1′. Other functions may be used that are a function of initial vid2. Party 2 communication module 320-2 sends hash(initial vid2) to Party 1 (1264) and Party 1 communication module 320-1 starts receiving hash(initial vid2)′ purportedly from Party 2 (1224). Once Party 1 communication module 320-1 receives hash(initial vid2)′, Party 1 communication module 320-1 sends initial vid1 and starts sending ongoing vid1 to Party 2 (1228). Party 2 communication module 320-2 receives initial vid1′ and starts receiving ongoing vid1′ purportedly from Party 1 (1268). Party 2 communication module 320-2 sends initial vid2 (or other data that reveals initial vid2) and starts sending ongoing vid2 to Party 1 (1272). Party 1 communication module 320-1 starts receiving initial vid2′ and ongoing vid2′ purportedly from Party 2 (1232).

Party 2 encoding module 315-2 forms hash′(initial vid1′, X1′) and Party 2 communication corruption detection module 335-2 performs a check that hash′(initial vid1′, X1′)=hash(initial vid1, X1)′. If the check fails Party 2 communication corruption detection module 335-2 determines that a communication corruption exists and Party 2 communication module 320-2 stops sending vid2 (1276). flash′ used by Party 2 and the hash function used by Party 1 may be a fixed hash function. However hash′ used by Party 2 and the hash function used by Party 1 may also be one of a variety of hash functions. In this case Party 1 may send an index to the hash function it used to Party 2, or alternatively Party 2 may by brute force perform the check with a variety of possible hash functions until the check does not fail or all hash functions have been tried.

Party 1 encoding module 315-1 forms hash′ (initial vid2′) and Party 2 communication corruption detection module 335-2 performs a check that hash′ (initial vid2′)=hash(initial vid2)′. If the check fails Party 1 communication corruption detection module 335-1 determines that a communication corruption exists and Party 1 communication module 320-1 stops sending vid1 (1236).

Vid1 and vid2 may include imagery of the faces/body of Party 1 and Party 2 and/or their local environments. Initial vid1 should have a continuity relationship with ongoing vid1. Initial vid2 should have a continuity relationship with ongoing vid2. Ongoing vid1′ should be displayed by Party 2 user interface module 325-2. Ongoing vid 2′ should be displayed by Party 1 user interface module 325-1. Ongoing vid1′ should have feedback through video content responsive to vid2. Ongoing vid2′ should have feedback through video content responsive to vid1. There should be randomness of video content including in initial vid1 and in initial vid2. In some embodiments Party 1 communication corruption detection module 335-1 may stop sending vid1 when initial vid1 or initial vid2′ is low entropy, which may occur with lens cover or incorrect camera settings. In some embodiments Party 2 communication corruption detection module 335-2 may stop sending vid2 when initial vid2 or initial vid1′ is low entropy, which may occur with lens cover or incorrect camera settings.

Party 1 continuity checking module 330-1 checks that initial vid2′ is continuous with ongoing vid2′. If the check fails Party 1 communication corruption detection module 335-1 determines that a communication corruption exists and Party 1 communication module 320-1 stops sending vid1 (1240). Continuity checking may be performed in many ways. In some embodiments it may involve Party 1 continuity checking module 330-1 determining whether image features between initial vid2′ and ongoing vid2′ are consistent within a predetermined error threshold automatically. In some embodiments it may involve Party 1 user interface module 325-1 displaying initial vid2′ side-by-side, overlapped or differenced with ongoing vid2′ and prompting Party 1 for user input about consistency which influences Party 1 continuity checking module 330-1. Displayed images may exaggerate inconsistencies or highlight image regions based on the magnitude of automatically determined error. Supporting methods used by the continuity checking module 330-1 in some embodiments may include motion tracking of local features and object models for tracking objects.

Party 2 continuity checking module 330-2 checks that initial vid1′ is continuous with ongoing vid1′. If the check fails Party 2 communication corruption detection module 335-2 determines that a communication corruption exists and Party 2 communication module 320-2 stops sending vid2 (1280). Continuity checking may be performed in many ways. In some embodiments it may involve Party 2 continuity checking module 330-2 determining whether image features between initial vid1′ and ongoing vid1′ are consistent within a predetermined error threshold automatically. In some embodiments it may involve Party 2 user interface module 325-2 displaying initial vid1′ side-by-side, overlapped or differenced with ongoing vid1′ and prompting Party 1 for input about consistency which influences Party 2 continuity checking module 330-2. Displayed images may exaggerate inconsistencies or highlight image regions based on the magnitude of automatically determined error. Supporting methods used by the continuity checking module 330-2 in some embodiments may include motion tracking of local features and object models for tracking objects.

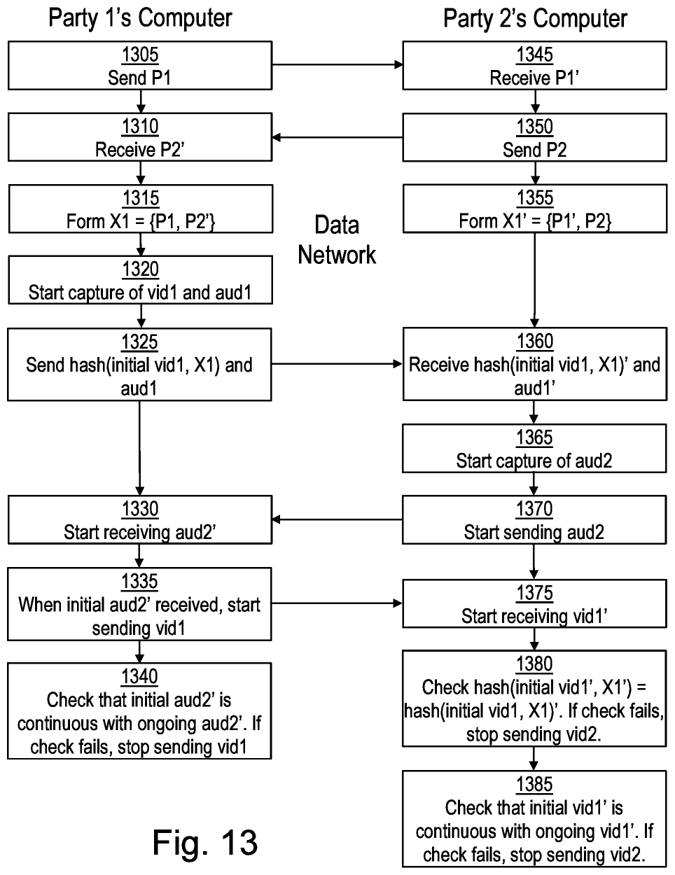

Embodiments related to FIG. 13 are similar to embodiments related to FIG. 5.

Party 1 call initialisation module 305-1 and Party 2 call initialisation module 305-2 initialise a data communication session. Party 1 communication module 320-1 sends P1 to Party 2 (1305) and Party 2 communication module 320-2 receives P1′ purportedly from Party 1 (1345). Party 2 communication module 320-2 sends P2 to Party 1 (1350) and Party 1 communication module 320-1 receives P2′ purportedly from Party 2 (1310). Party 1 call initialisation module 305-1 forms X1 data as the concatenation of P1 and P2′ (1315) and Party 2 call initialisation module 305-2 forms X1′ data as the concatenation of P1′ and P2 (1355).

Party 1 video and/or audio capture module 310-1 starts capture of Party 1 video vid1 and audio aud1 (1320). Party 1 encoding module 315-1 applies a hash function to the initial vid1 and to X1 to produce a hash value hash(initial vid1, X1). The hash function may be a cryptographic hash function or other function that binds together initial vid1 and X1 without revealing initial vid1. Party 1 communication module 320-1 sends hash(initial vid1, X1) and aud1 to Party 2 (1325) and Party 2 communication module 320-2 receives hash(initial vid1, X1)′ and aud1′ purportedly from Party 1 (1360). Party 2 video and/or audio capture module 310-2 starts capture of Party 2 audio aud2 (1365). Party 2 communication module 320-2 starts sending aud2 to Party 1 (1370) and Party 1 communication module 320-1 starts receiving aud2′ purportedly from Party 2 (1330). Once Party 1 communication module 320-1 receives some initial aud2′ containing speech (speech may be automatically detected), Party 1 communication module 320-1 sends initial vid1 and starts sending ongoing vid1 to Party 2 (1335). Party 2 communication module 320-2 receives initial vid1′ and starts receiving ongoing vid1′ purportedly from Party 1 (1375).

Party 2 encoding module 315-2 forms hash′(initial vid1′, X1′) and Party 2 communication corruption detection module 335-2 performs a check that hash′(initial vid1′, X1′)=hash(initial vid1, X1)′. If the check fails Party 2 communication corruption detection module 335-2 determines that a communication corruption exists and Party 2 communication module 320-2 stops sending vid2 (1380). Hash′ used by Party 2 and the hash function used by Party 1 may be a fixed hash function. However hash′ used by Party 2 and the hash function used by Party 1 may also be one of a variety of hash functions. In this case Party 1 may send an index to the hash function it used to Party 2, or alternatively Party 2 may by brute force perform the check with a variety of possible hash functions until the check does not fail or all hash functions have been tried.

Vid1 may include imagery of the faces/body of Party 1 and/or Party 1 local environment. Aud2 may include audio of the speech of Party 1 and/or Party 1 local environment. Initial vid1 should have a continuity relationship with ongoing vid1. Initial aud2 should have a continuity relationship with ongoing aud2. Ongoing vid1′ should be displayed by Party 1 user interface module 325-1. Ongoing aud2′ should be displayed by Party 2 user interface module 325-2. Ongoing vid1′ should have feedback through video content responsive to aud2. Ongoing aud2′ should have feedback through audio content responsive to vid1. There should be randomness of video content including in initial vid1 and randomness of audio content including in initial aud2. In some embodiments Party 1 communication corruption detection module 335-1 may stop sending vid1 when initial vid1 is low entropy, which may occur with lens cover or incorrect camera settings. In some embodiments Party 2 communication corruption detection module 335-2 may stop sending aud2 when initial vid1′ is low entropy, which may occur with lens cover or incorrect camera settings.

Party 1 continuity checking module 330-1 checks that initial aud2′ is continuous with ongoing aud2′. If the check fails Party 1 communication corruption detection module 335-1 determines that a communication corruption exists and Party 1 communication module 320-1 stops sending vid1 (1340). Continuity checking may be performed in many ways. In some embodiments it may involve Party 1 continuity checking module 330-1 determining whether audio features between initial aud2′ and ongoing aud2′ are consistent within a predetermined error threshold automatically. In some embodiments it may involve Party 1 user interface module 325-1 displaying initial aud2′ before ongoing aud2′ and prompting Party 1 for user input about consistency which influences Party 1 continuity checking module 330-1. Displayed audio may exaggerate inconsistencies or highlight audio regions based on the magnitude of automatically determined error. Supporting methods used by the continuity checking module 330-1 in some embodiments may include background noise processing and speech processing.

Party 2 continuity checking module 330-2 checks that initial vid1′ is continuous with ongoing vid1′. If the check fails Party 2 communication corruption detection module 335-2 determines that a communication corruption exists and Party 2 communication module 320-2 stops sending aud2 (1385). Continuity checking may be performed in many ways. In some embodiments it may involve Party 2 continuity checking module 330-2 determining whether image features between initial vid1′ and ongoing vid1′ are consistent within a predetermined error threshold automatically. In some embodiments it may involve Party 2 user interface module 325-2 displaying initial vid1′ side-by-side, overlapped or differenced with ongoing vid1′ and prompting Party 1 for input about consistency which influences Party 2 continuity checking module 330-2. Displayed images may exaggerate inconsistencies or highlight image regions based on the magnitude of automatically determined error. Supporting methods used by the continuity checking module 330-2 in some embodiments may include motion tracking of local features and object models for tracking objects.

Embodiments related to FIG. 14 are similar to embodiments related to FIG. 5.

Party 1 call initialisation module 305-1 and Party 2 call initialisation module 305-2 initialise a data communication session. Party 1 communication module 320-1 sends P1 to Party 2 (1404) and Party 2 communication module 320-2 receives P1′ purportedly from Party 1 (1444). Party 2 communication module 320-2 sends P2 to Party 1 (1448) and Party 1 communication module 320-1 receives P2′ purportedly from Party 2 (1408). Party 1 call initialisation module 305-1 forms X1 data as the concatenation of P1 and P2′ (1412) and Party 2 call initialisation module 305-2 forms X1′ data as the concatenation of P1′ and P2 (1452).

Party 1 video and/or audio capture module 310-1 starts capture of Party 1 video vid1 (1416). Party 1 encoding module 315-1 applies a hash function to the initial vid1 and to X1 to produce a hash value hash(initial vid1, X1). The hash function may be a cryptographic hash function or other function that binds together initial vid1 and X1 without revealing initial vid1. Party 1 communication module 320-1 sends hash(initial vid1, X1) to Party 2 (1420) and after a time delay of T1 seconds (1424) sends initial vid1 to Party 2 (1428). Party 2 communication module 320-2 receives hash(initial vid1, X1)′ purportedly from Party 1 (1456) and after a time delay of T2 seconds, Party 2 video and/or audio capture module 310-2 starts capture of Party 2 video vid2 (1468). Party 2 communication module 320-2 starts sending vid2 to Party 1 (1472). Party 2 communication module 320-2 receives initial vid1′ and starts receiving ongoing vid 1 ‘ purportedly from Party 1 (1464). Party 1 communication module 320-1 starts receiving vid2’ purportedly from Party 2 (1432). Party 1 communication corruption detection module 335-1 checks whether initial vid2′, such as a frame of vid2′ is received by Party 1 communication module 320-1 by a time delay of T1+T2 seconds after Party 1 communication module 320-1 sending hash(initial vid1, X1). If the check fails Party 1 communication corruption detection module 335-1 determines that a communication corruption exists and Party 1 communication module 320-1 stops sending vid1 (1436).

Party 2 encoding module 315-2 forms hash′(initial vid1′, X1′) and Party 2 communication corruption detection module 335-2 performs a check that hash′(initial vid1′, X1′)=hash(initial vid1, X1)′. If the check fails Party 2 communication corruption detection module 335-2 determines that a communication corruption exists and Party 2 communication module 320-2 stops sending vid2 (1476). Hash′ used by Party 2 and the hash function used by Party 1 may be a fixed hash function. However hash′ used by Party 2 and the hash function used by Party 1 may also be one of a variety of hash functions. In this case Party 1 may send an index to the hash function it used to Party 2, or alternatively Party 2 may by brute force perform the check with a variety of possible hash functions until the check does not fail or all hash functions have been tried.

Vid1 and vid2 may include imagery of the faces/body of Party 1 and Party 2 and/or their local environments. Initial vid1 should have a continuity relationship with ongoing vid1. Initial vid2 should have a continuity relationship with ongoing vid2. Ongoing vid1′ should be displayed by Party 2 user interface module 325-2. Ongoing vid 2′ should be displayed by Party 1 user interface module 325-1. Ongoing vid1′ should have feedback through video content responsive to vid2. Ongoing vid2′ should have feedback through video content responsive to vid1. There should be randomness of video content including in initial vid1 and in initial vid2. In some embodiments Party 1 communication corruption detection module 335-1 may stop sending vid1 when initial vid1 or initial vid2′ is low entropy, which may occur with lens cover or incorrect camera settings. In some embodiments Party 2 communication corruption detection module 335-2 may stop sending vid2 when initial vid2 or initial vid1′ is low entropy, which may occur with lens cover or incorrect camera settings.

Party 1 continuity checking module 330-1 checks that initial vid2′ is continuous with ongoing vid2′. If the check fails Party 1 communication corruption detection module 335-1 determines that a communication corruption exists and Party 1 communication module 320-1 stops sending vid1 (1440). Continuity checking may be performed in many ways. In some embodiments it may involve Party 1 continuity checking module 330-1 determining whether image features between initial vid2′ and ongoing vid2′ are consistent within a predetermined error threshold automatically. In some embodiments it may involve Party 1 user interface module 325-1 displaying initial vid2′ side-by-side, overlapped or differenced with ongoing vid2′ and prompting Party 1 for user input about consistency which influences Party 1 continuity checking module 330-1. Displayed images may exaggerate inconsistencies or highlight image regions based on the magnitude of automatically determined error. Supporting methods used by the continuity checking module 330-1 in some embodiments may include motion tracking of local features and object models for tracking objects.

Party 2 continuity checking module 330-2 checks that initial vid1′ is continuous with ongoing vid1′. If the check fails Party 2 communication corruption detection module 335-2 determines that a communication corruption exists and Party 2 communication module 320-2 stops sending vid2 (1480). Continuity checking may be performed in many ways. In some embodiments it may involve Party 2 continuity checking module 330-2 determining whether image features between initial vid1′ and ongoing vid1′ are consistent within a predetermined error threshold automatically. In some embodiments it may involve Party 2 user interface module 325-2 displaying initial vid1′ side-by-side, overlapped or differenced with ongoing vid1′ and prompting Party 1 for input about consistency which influences Party 2 continuity checking module 330-2. Displayed images may exaggerate inconsistencies or highlight image regions based on the magnitude of automatically determined error. Supporting methods used by the continuity checking module 330-2 in some embodiments may include motion tracking of local features and object models for tracking objects.

Embodiments related to FIG. 15 are similar to embodiments related to FIG. 5.

Party 1 call initialisation module 305-1 and Party 2 call initialisation module 305-2 initialise a data communication session. Party 1 call initialisation module 305-1 applies a hash function to previously undisclosed P1 to produce hash(P1). The hash function may be a cryptographic hash function. Party 1 communication module 320-1 sends hash(P1) to Party 2 (1504) and Party 2 communication module 320-2 receives hash(P1)′ purportedly from Party 1 (1544). Party 2 communication module 320-2 sends previously undisclosed P2 to Party 1 (1548) and Party 1 communication module 320-1 receives P2′ purportedly from Party 2 (1508). Party 1 communication module 320-1 sends P1 to Party 2 (1512) and Party 2 communication module 320-2 receives P1′ purportedly from Party 1 (1552). Party 2 call initialisation module 305-2 applies the same hash function purportedly used to create hash(P1)′ to P1′ to produce hash′ (P1). Party 2 communication corruption detection module 335-2 performs a check (1556) that hash′ (P1′)=hash(P1)′. If the check fails Party 2 communication corruption detection module 335-2 determines that a communication corruption exists and terminates the call. Party 1 call initialisation module 305-1 forms 16 bit X1 data by applying a hash function to the concatenation of P1 and P2′ (1516) and Party 2 call initialisation module 305-2 forms 16 bit X1′ data by applying the same hash function to the concatenation of P1′ and P2 (1560). The X1 and X1′ data may be less than 16 bits or longer than 16 bits in some embodiments.

Party 1 video and/or audio capture module 310-1 starts capture of Party 1 video vid1 (1520). Party 1 encoding module 315-1 divides the 16 bit hash value X1 into 8 pieces of 2 bits, denoted X1(i), where i=1 to 8. Thus each X1(i) represents values 0 to 3. Party 1 encoding module 315-1 segments initial vid1 into 16 wedges going to the middle of the frame like a sliced pizza. The initial vid1 may be segmented into parts other ways. These wedges are denoted vid1(j), where j=1 to 16. After a delay of 2X1(i) seconds (e.g. if X1(i)=2 then delay=4 seconds), Party 1 communication module 320-1 sends (1524) vid(i) to Party 2. A different function of X1(i) may be used for calculating the delay. Longer delays may be useful where there is more latency in communications. In parallel, after a delay of 6-2X(i) seconds (e.g. if X(i)=2 then delay=2 seconds), Party 1 communication module 320-1 sends vid(2i) to Party 2 (1524). Vid(2i) represents the wedge of initial vid1 opposite vid(i). Using two inversely related time delays in this way to encode each X1(i) means that vid1(j) wedge cannot be delayed to represent an alternative X1 without sending the opposite vid1(j) wedge earlier. In some embodiments Party 1 may send a function of the vid1(j), instead of the vid(j), such as a hash or encryption of vid(j). After sending all the vid(j) Party 1 communication module 320-1 sends ongoing vid1 to Party 2 (1528). Party 2 communication module 320-2 receives the vid(j)′ purportedly from Party 1 (1564) and records their relative times of arrival. Party 2 communication module 320-2 receives ongoing vid1′ purportedly from Party 1 (1568). After a time delay of T1 seconds of receiving the first vid1(j)′, Party 2 video and/or audio capture module 310-2 starts capture of Party 2 video vid2 (1572) and Party 2 communication module 320-2 starts sending vid2 to Party 1 (1572). Party 1 communication module 320-1 starts receiving vid2′ purportedly from Party 2 (1532). Party 1 communication corruption detection module 335-1 checks whether initial vid2′, such as a frame of vid2′ is received by Party 1 communication module 320-1 by a time delay of T1+2 seconds after Party 1 communication module 320-1 sending the earliest vid1(j). If the check fails Party 1 communication corruption detection module 335-1 determines that a communication corruption exists and Party 1 communication module 320-1 stops sending vid1 (1536).

Party 2 encoding module 315-2 uses X1′ to calculate the expected time delays of receiving each vid1(j) after receiving the earliest vid(j). Party 2 communication corruption detection module 335-2 performs a check that time delays of receiving each vid1(j) after receiving the earliest vid(j)<2 seconds+expected time delays of receiving each vid1(j) after receiving the earliest vid(j). If the check fails Party 2 communication corruption detection module 335-2 determines that a communication corruption exists and Party 2 communication module 320-2 stops sending vid2 (1576).

Vid1 and vid2 may include imagery of the faces/body of Party 1 and Party 2 and/or their local environments. Initial vid1 should have a continuity relationship with ongoing vid1. Initial vid2 should have a continuity relationship with ongoing vid2. Ongoing vid1′ should be displayed by Party 2 user interface module 325-2. Ongoing vid 2′ should be displayed by Party 1 user interface module 325-1. Ongoing vid1′ should have feedback through video content responsive to vid2. Ongoing vid2′ should have feedback through video content responsive to vid1. There should be randomness of video content including in initial vid1 and in initial vid2. In some embodiments Party 1 communication corruption detection module 335-1 may stop sending vid1 when initial vid1 or initial vid2′ is low entropy, which may occur with lens cover or incorrect camera settings. In some embodiments Party 2 communication corruption detection module 335-2 may stop sending vid2 when initial vid2 or initial vid1′ is low entropy, which may occur with lens cover or incorrect camera settings.

Party 1 continuity checking module 330-1 checks that initial vid2′ is continuous with ongoing vid2′. If the check fails Party 1 communication corruption detection module 335-1 determines that a communication corruption exists and Party 1 communication module 320-1 stops sending vid1 (1540). Continuity checking may be performed in many ways. In some embodiments it may involve Party 1 continuity checking module 330-1 determining whether image features between initial vid2′ and ongoing vid2′ are consistent within a predetermined error threshold automatically. In some embodiments it may involve Party 1 user interface module 325-1 displaying initial vid2′ side-by-side, overlapped or differenced with ongoing vid2′ and prompting Party 1 for user input about consistency which influences Party 1 continuity checking module 330-1. Displayed images may exaggerate inconsistencies or highlight image regions based on the magnitude of automatically determined error. Supporting methods used by the continuity checking module 330-1 in some embodiments may include motion tracking of local features and object models for tracking objects.

Party 2 continuity checking module 330-2 checks that initial vid1′ is continuous with ongoing vid1′. If the check fails Party 2 communication corruption detection module 335-2 determines that a communication corruption exists and Party 2 communication module 320-2 stops sending vid2 (1580). Continuity checking may be performed in many ways. In some embodiments it may involve Party 2 continuity checking module 330-2 determining whether image features between initial vid1′ and ongoing vid1′ are consistent within a predetermined error threshold automatically. In some embodiments it may involve Party 2 user interface module 325-2 displaying initial vid1′ side-by-side, overlapped or differenced with ongoing vid1′ and prompting Party 1 for input about consistency which influences Party 2 continuity checking module 330-2. Displayed images may exaggerate inconsistencies or highlight image regions based on the magnitude of automatically determined error. Supporting methods used by the continuity checking module 330-2 in some embodiments may include motion tracking of local features and object models for tracking objects.

Embodiments related to FIG. 16 are similar to embodiments related to FIG. 5.

Party 1 call initialisation module 305-1 and Party 2 call initialisation module 305-2 initialise a data communication session. Party 1 communication module 320-1 sends P1 to Party 2 (1604) and Party 2 communication module 320-2 receives P1′ purportedly from Party 1 (1640). Party 2 communication module 320-2 sends P2 to Party 1 (1644) and Party 1 communication module 320-1 receives P2′ purportedly from Party 2 (1608). Party 1 call initialisation module 305-1 forms X1 data as the concatenation of P1 and P2′ (1612) and Party 2 call initialisation module 305-2 forms X1′ data as the concatenation of P1′ and P2 (1648).

Party 2 video and/or audio capture module 310-2 starts capture of Party 2 video vid2 (1652). Party 2 communication module 320-2 starts sending vid2 to Party 1 (1656). Party 1 communication module 320-1 starts receiving vid2′ purportedly from Party 2 (1616). Party 1 video and/or audio capture module 310-1 starts capture of Party 1 video vid1 (1620). Party 1 encoding module 315-1 applies a hash function to the initial vid1 and to X1 to produce a hash value hash(initial vid1, X1). The hash function may be a cryptographic hash function or other function that binds together initial vid1 and X1 without revealing initial vid1. After receiving initial vid2′, such as a frame of vid2′, Party 1 communication module 320-1 sends hash(initial vid1, X1) to Party 2 (1624) and after a time delay of T1 seconds (1628) sends initial vid1 and starts sending ongoing vid1 to Party 2 (1632). Party 2 communication module 320-2 receives hash(initial vid1, X1)′ purportedly from Party 1 (1660). Party 2 communication corruption detection module 335-2 checks whether hash(initial vid1, X1)′ was received by Party 2 communication module 320-2 by a time delay of T1 seconds after Party 2 communication module 320-2 sending initial vid2. If the check fails Party 2 communication corruption detection module 335-2 determines that a communication corruption exists and Party 2 communication module 320-2 stops sending vid2 (1664).

Party 2 communication module 320-2 receives initial vid1′ and starts receiving ongoing vid1′ purportedly from Party 1 (1668).

Party 2 encoding module 315-2 forms hash′ (initial vid1′, X1′) and Party 2 communication corruption detection module 335-2 performs a check that hash′ (initial vid1′, X1′)=hash(initial vid1, X1)′. If the check fails Party 2 communication corruption detection module 335-2 determines that a communication corruption exists and Party 2 communication module 320-2 stops sending vid2 (1672). Hash′ used by Party 2 and the hash function used by Party 1 may be a fixed hash function. However hash′ used by Party 2 and the hash function used by Party 1 may also be one of a variety of hash functions. In this case Party 1 may send an index to the hash function it used to Party 2, or alternatively Party 2 may by brute force perform the check with a variety of possible hash functions until the check does not fail or all hash functions have been tried.

Vid1 and vid2 may include imagery of the faces/body of Party 1 and Party 2 and/or their local environments. Initial vid1 should have a continuity relationship with ongoing vid1. Initial vid2 should have a continuity relationship with ongoing vid2. Ongoing vid1′ should be displayed by Party 2 user interface module 325-2. Ongoing vid 2′ should be displayed by Party 1 user interface module 325-1. Ongoing vid1′ should have feedback through video content responsive to vid2. Ongoing vid2′ should have feedback through video content responsive to vid1. There should be randomness of video content including in initial vid1 and in initial vid2. In some embodiments Party 1 communication corruption detection module 335-1 may stop sending vid1 when initial vid1 or initial vid2′ is low entropy, which may occur with lens cover or incorrect camera settings. In some embodiments Party 2 communication corruption detection module 335-2 may stop sending vid2 when initial vid2 or initial vid1′ is low entropy, which may occur with lens cover or incorrect camera settings.

Party 1 continuity checking module 330-1 checks that initial vid2′ is continuous with ongoing vid2′. If the check fails Party 1 communication corruption detection module 335-1 determines that a communication corruption exists and Party 1 communication module 320-1 stops sending vid1 (1636). Continuity checking may be performed in many ways. In some embodiments it may involve Party 1 continuity checking module 330-1 determining whether image features between initial vid2′ and ongoing vid2′ are consistent within a predetermined error threshold automatically. In some embodiments it may involve Party 1 user interface module 325-1 displaying initial vid2′ side-by-side, overlapped or differenced with ongoing vid2′ and prompting Party 1 for user input about consistency which influences Party 1 continuity checking module 330-1. Displayed images may exaggerate inconsistencies or highlight image regions based on the magnitude of automatically determined error. Supporting methods used by the continuity checking module 330-1 in some embodiments may include motion tracking of local features and object models for tracking objects.

Party 2 continuity checking module 330-2 checks that initial vid1′ is continuous with ongoing vid1′. If the check fails Party 2 communication corruption detection module 335-2 determines that a communication corruption exists and Party 2 communication module 320-2 stops sending vid2 (1676). Continuity checking may be performed in many ways. In some embodiments it may involve Party 2 continuity checking module 330-2 determining whether image features between initial vid1′ and ongoing vid1′ are consistent within a predetermined error threshold automatically. In some embodiments it may involve Party 2 user interface module 325-2 displaying initial vid1′ side-by-side, overlapped or differenced with ongoing vid1′ and prompting Party 1 for input about consistency which influences Party 2 continuity checking module 330-2. Displayed images may exaggerate inconsistencies or highlight image regions based on the magnitude of automatically determined error. Supporting methods used by the continuity checking module 330-2 in some embodiments may include motion tracking of local features and object models for tracking objects.

Embodiments related to FIG. 17 are similar to embodiments related to FIG. 5.

Party 1 call initialisation module 305-1 and Party 2 call initialisation module 305-2 initialise a data communication session. Party 1 call initialisation module 305-1 applies a hash function to previously undisclosed P1 to produce hash(P1). The hash function may be a cryptographic hash function. Party 1 communication module 320-1 sends hash(P1) to Party 2 (1704) and Party 2 communication module 320-2 receives hash(P1)′ purportedly from Party 1 (1740). Party 2 communication module 320-2 sends previously undisclosed P2 to Party 1 (1744) and Party 1 communication module 320-1 receives P2′ purportedly from Party 2 (1708). Party 1 communication module 320-1 sends P1 to Party 2 (1712) and Party 2 communication module 320-2 receives P1′ purportedly from Party 1 (1748). Party 2 call initialisation module 305-2 applies the same hash function purportedly used to create hash(P1)′ to P1′ to produce hash′ (P1).

Party 2 communication corruption detection module 335-2 performs a check (1752) that hash′(P1′)=hash(P1)′. If the check fails Party 2 communication corruption detection module 335-2 determines that a communication corruption exists and terminates the call. Party 1 call initialisation module 305-1 forms 16 bit X1 data by applying a hash function to the concatenation of P1 and P2′ (1716) and Party 2 call initialisation module 305-2 forms 16 bit X1′ data by applying the same hash function to the concatenation of P1′ and P2 (1756). The X1 and X1′ data may be less than 16 bits or longer than 16 bits in some embodiments.

Party 2 video and/or audio capture module 310-2 starts capture of Party 2 video vid2 and Party 2 communication module 320-2 starts sending vid2 to Party 1 (1760). Party 1 communication module 320-1 starts receiving vid2′ purportedly from Party 2 (1720). After initial vid2′, such as a frame of vid2′, is received by Party 1 communication module 320-1, Party 1 video and/or audio capture module 310-1 starts capture of Party 1 video vid1 (1724). Party 1 encoding module 315-1 divides the 16 bit hash value X1 into 8 pieces of 2 bits, denoted X1(i), where i=1 to 8. Thus each X1(i) represents values 0 to 3. Party 1 encoding module 315-1 segments initial vid1 into 16 wedges going to the middle of the frame like a sliced pizza. The initial vid1 may be segmented into parts other ways. These wedges are denoted vid1(j), where j=1 to 16. After a delay of 2X1(i) seconds (e.g. if X1(i)=2 then delay=4 seconds), Party 1 communication module 320-1 sends (1728) vid(i) to Party 2. A different function of X1(i) may be used for calculating the delay. Longer delays may be useful where there is more latency in communications. In parallel, after a delay of 6-2X(i) seconds (e.g. if X(i)=2 then delay=2 seconds), Party 1 communication module 320-1 sends vid(2i) to Party 2 (1728). Vid(2i) represents the wedge of initial vid1 opposite vid(i). Using two inversely related time delays in this way to encode each X1(i) means that vid1(j) wedge cannot be delayed to represent an alternative X1 without sending the opposite vid1(j) wedge earlier. In some embodiments Party 1 may send a function of the vid1(j), instead of the vid(j), such as a hash or encryption of vid(j). After sending all the vid(j) Party 1 communication module 320-1 sends ongoing vid1 to Party 2 (1732). Party 2 communication module 320-2 receives the vid(j)′ purportedly from Party 1 (1764) and records their times of arrival relative to the time that Party 2 communication module 320-2 sent initial vid2′. Party 2 communication module 320-2 receives ongoing vid1′ purportedly from Party 1 (1768).

Party 2 encoding module 315-2 uses X1′ to calculate the expected times of receiving each vid1(j) relative to the time that Party 2 communication module 320-2 sent initial vid2′. Party 2 communication corruption detection module 335-2 performs a check that times of receiving each vid1(j) relative to the time that Party 2 communication module 320-2 sent initial vid2′<2 seconds+expected times of receiving each vid1(j) relative to the time that Party 2 communication module 320-2 sent initial vid2′. If the check fails Party 2 communication corruption detection module 335-2 determines that a communication corruption exists and Party 2 communication module 320-2 stops sending vid2 (1772).

Vid1 and vid2 may include imagery of the faces/body of Party 1 and Party 2 and/or their local environments. Initial vid1 should have a continuity relationship with ongoing vid1. Initial vid2 should have a continuity relationship with ongoing vid2. Ongoing vid1′ should be displayed by Party 2 user interface module 325-2. Ongoing vid 2′ should be displayed by Party 1 user interface module 325-1. Ongoing vid1′ should have feedback through video content responsive to vid2. Ongoing vid2′ should have feedback through video content responsive to vid1. There should be randomness of video content including in initial vid1 and in initial vid2. In some embodiments Party 1 communication corruption detection module 335-1 may stop sending vid1 when initial vid1 or initial vid2′ is low entropy, which may occur with lens cover or incorrect camera settings. In some embodiments Party 2 communication corruption detection module 335-2 may stop sending vid2 when initial vid2 or initial vid1′ is low entropy, which may occur with lens cover or incorrect camera settings.

Party 1 continuity checking module 330-1 checks that initial vid2′ is continuous with ongoing vid2′. If the check fails Party 1 communication corruption detection module 335-1 determines that a communication corruption exists and Party 1 communication module 320-1 stops sending vid1 (1736). Continuity checking may be performed in many ways. In some embodiments it may involve Party 1 continuity checking module 330-1 determining whether image features between initial vid2′ and ongoing vid2′ are consistent within a predetermined error threshold automatically. In some embodiments it may involve Party 1 user interface module 325-1 displaying initial vid2′ side-by-side, overlapped or differenced with ongoing vid2′ and prompting Party 1 for user input about consistency which influences Party 1 continuity checking module 330-1. Displayed images may exaggerate inconsistencies or highlight image regions based on the magnitude of automatically determined error. Supporting methods used by the continuity checking module 330-1 in some embodiments may include motion tracking of local features and object models for tracking objects.

Party 2 continuity checking module 330-2 checks that initial vid1′ is continuous with ongoing vid1′. If the check fails Party 2 communication corruption detection module 335-2 determines that a communication corruption exists and Party 2 communication module 320-2 stops sending vid2 (1776). Continuity checking may be performed in many ways. In some embodiments it may involve Party 2 continuity checking module 330-2 determining whether image features between initial vid1′ and ongoing vid1′ are consistent within a predetermined error threshold automatically. In some embodiments it may involve Party 2 user interface module 325-2 displaying initial vid1′ side-by-side, overlapped or differenced with ongoing vid1′ and prompting Party 1 for input about consistency which influences Party 2 continuity checking module 330-2. Displayed images may exaggerate inconsistencies or highlight image regions based on the magnitude of automatically determined error. Supporting methods used by the continuity checking module 330-2 in some embodiments may include motion tracking of local features and object models for tracking objects.

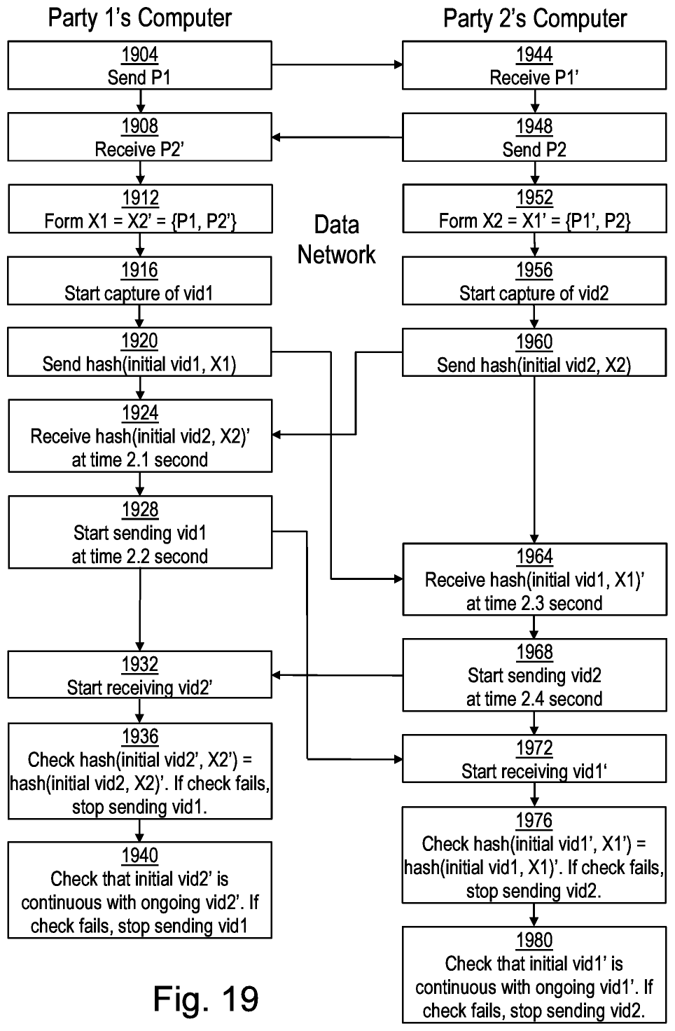

Embodiments related to FIG. 18 and FIG. 19 are similar to embodiments related to FIG. 5.

Party 1 call initialisation module 305-1 and Party 2 call initialisation module 305-2 initialise a data communication session. Party 1 communication module 320-1 sends P1 to Party 2 (1804, 1904) and Party 2 communication module 320-2 receives P1′ purportedly from Party 1 (1844, 1944). Party 2 communication module 320-2 sends P2 to Party 1 (1848, 1948) and Party 1 communication module 320-1 receives P2′ purportedly from Party 2 (1808, 1908). Party 1 call initialisation module 305-1 forms X1 data and X2′ data as the concatenation of P1 and P2′ (1812, 1912) and Party 2 call initialisation module 305-2 forms X2 data and X1′ data as the concatenation of P1′ and P2 (1852, 1952).

Party 1 video and/or audio capture module 310-1 starts capture of Party 1 video vid1 (1816, 1916). Party 2 video and/or audio capture module 310-2 starts capture of Party 2 video vid1 (1856, 1956). Party 1 encoding module 315-1 applies a hash function to the initial vid1 and to X1 to produce a hash value hash1(initial vid1, X1). The hash function may be a cryptographic hash function or other function that binds together initial vid1 and X1 without revealing initial vid1. Party 2 encoding module 315-2 applies a hash function to the initial vid2 and to X2 to produce a hash value hash2(initial vid2, X2). The hash function may be a cryptographic hash function or other function that binds together initial vid2 and X2 without revealing initial vid2. Party 1 communication module 320-1 sends hash1(initial vid1, X1) to Party 2 (1820, 1920) and Party 2 communication module 320-2 sends hash1(initial vid2, X2) to Party 2 (1860, 1960). Party 2 communication module 320-2 receives hash1(initial vid1, X1)′ purportedly from Party 1 (1864, 1964) and thereafter Party 2 communication module 320-2 starts sending vid2 to Party 1 (1868, 1968). Party 1 communication module 320-1 receives hash2(initial vid2, X2)′ purportedly from Party 2 (1824, 1924) and thereafter Party 1 communication module 320-1 starts sending vid1 to Party 2 (1828, 1928). Party 2 communication module 320-2 receives initial vid1′ and starts receiving ongoing vid1′ purportedly from Party 1 (1872, 1972). Party 1 communication module 320-1 receives initial vid2′ and starts receiving ongoing vid2′ purportedly from Party 2 (1832, 1932).

Party 2 encoding module 315-2 forms hash1′(initial vid1 X1′) and Party 2 communication corruption detection module 335-2 performs a check that hash l′ (initial vid1′, X1′)=hash1(initial vid1, X1)′. If the check fails Party 2 communication corruption detection module 335-2 determines that a communication corruption exists and Party 2 communication module 320-2 stops sending vid2 (1876, 1976). Hash1′ used by Party 2 and the hash1 function used by Party 1 may be a fixed hash function. However hash1′ used by Party 2 and the hash1 function used by Party 1 may also be one of a variety of hash functions. In this case Party 1 may send an index to the hash1 function it used to Party 2, or alternatively Party 2 may by brute force perform the check with a variety of possible hash functions until the check does not fail or all hash functions have been tried.

Party 1 encoding module 315-1 forms hash2′(initial vid2′, X2′) and Party 2 communication corruption detection module 335-1 performs a check that hash2′ (initial vid2′, X1′)=hash2(initial vid1, X1)′. If the check fails Party 1 communication corruption detection module 335-1 determines that a communication corruption exists and Party 1 communication module 320-1 stops sending vid1 (1836, 1936). Hash2′ used by Party 1 and the hash2 function used by Party 2 may be a fixed hash function. However hash2′ used by Party 1 and the hash2 function used by Party 2 may also be one of a variety of hash functions. In this case Party 2 may send an index to the hash2 function it used to Party 1, or alternatively Party 1 may by brute force perform the check with a variety of possible hash functions until the check does not fail or all hash functions have been tried.

Vid1 and vid2 may include imagery of the faces/body of Party 1 and Party 2 and/or their local environments. Initial vid1 should have a continuity relationship with ongoing vid1. Initial vid2 should have a continuity relationship with ongoing vid2. Ongoing vid1′ should be displayed by Party 2 user interface module 325-2. Ongoing vid 2′ should be displayed by Party 1 user interface module 325-1. Ongoing vid1′ should have feedback through video content responsive to vid2. Ongoing vid2′ should have feedback through video content responsive to vid1. There should be randomness of video content including in initial vid1 and in initial vid2. In some embodiments Party 1 communication corruption detection module 335-1 may stop sending vid1 when initial vid1 or initial vid2′ is low entropy, which may occur with lens cover or incorrect camera settings. In some embodiments Party 2 communication corruption detection module 335-2 may stop sending vid2 when initial vid2 or initial vid1′ is low entropy, which may occur with lens cover or incorrect camera settings.

Party 1 continuity checking module 330-1 checks that initial vid2′ is continuous with ongoing vid2′. If the check fails Party 1 communication corruption detection module 335-1 determines that a communication corruption exists and Party 1 communication module 320-1 stops sending vid1 (1840, 1940). Continuity checking may be performed in many ways. In some embodiments it may involve Party 1 continuity checking module 330-1 determining whether image features between initial vid2′ and ongoing vid2′ are consistent within a predetermined error threshold automatically. In some embodiments it may involve Party 1 user interface module 325-1 displaying initial vid2′ side-by-side, overlapped or differenced with ongoing vid2′ and prompting Party 1 for user input about consistency which influences Party 1 continuity checking module 330-1. Displayed images may exaggerate inconsistencies or highlight image regions based on the magnitude of automatically determined error. Supporting methods used by the continuity checking module 330-1 in some embodiments may include motion tracking of local features and object models for tracking objects.

Party 2 continuity checking module 330-2 checks that initial vid1′ is continuous with ongoing vid1′. If the check fails Party 2 communication corruption detection module 335-2 determines that a communication corruption exists and Party 2 communication module 320-2 stops sending vid2 (1880, 1980). Continuity checking may be performed in many ways. In some embodiments it may involve Party 2 continuity checking module 330-2 determining whether image features between initial vid1′ and ongoing vid1′ are consistent within a predetermined error threshold automatically. In some embodiments it may involve Party 2 user interface module 325-2 displaying initial vid1′ side-by-side, overlapped or differenced with ongoing vid1′ and prompting Party 1 for input about consistency which influences Party 2 continuity checking module 330-2. Displayed images may exaggerate inconsistencies or highlight image regions based on the magnitude of automatically determined error. Supporting methods used by the continuity checking module 330-2 in some embodiments may include motion tracking of local features and object models for tracking objects.

Party 2 may start sending vid2 (1868) before Party 1 receives hash2(initial vid2, X2)′ (1824). However in this case, Party 2 will receive hash1(initial vid1, X1)′ (1864) before Party 1 starts sending vid1 (1828). Party 1 may start sending vid1 (1928) before Party 2 receives hash1(initial vid1, X1)′ (1964). However in this case, Party 1 will receive hash2(initial vid2, X2)′ (1924) before Party 2 starts sending vid2 (1968).

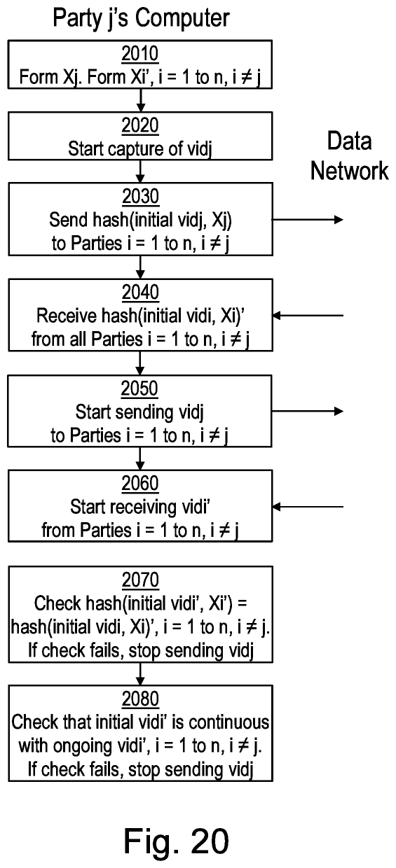

Embodiments related to FIG. 20 are similar to embodiments related to FIG. 18 and FIG. 19. Embodiments related to FIG. 20 are one alternative to extend embodiments related to FIGS. 18 and 19 to n parties

Party j call initialisation module 305-j initialises a data communication session. Party j call initialisation module 305-1 forms Xj data and Xi′ data for Parties i=1 to n, i≠j (2010). Party j video and/or audio capture module 310-j starts capture of Party j video vidj (2020). Party j encoding module 315-j applies a hash function to the initial vidj and to Xj to produce a hash value hashj(initial vidj, Xj). The hash function may be a cryptographic hash function or other function that binds together initial vidj and Xj without revealing initial vidj. Party j communication module 320-j sends hashj(initial vidj, Xj) to Parties i=1 to n, i≠j (2030). Party 1 communication module 320-j receives hashi(initial vidi, Xi)′ purportedly from all Parties i=1 to n, i≠j (2040) and thereafter Party j communication module 320-j starts sending vidj to Parties i=1 to n, i≠j (2050). Party j communication module 320-j receives initial vidj′ and ongoing vidj′ purportedly from Parties i=1 to n, i≠j (2060). Party j encoding module 315-j forms hashi′(initial vidi′, Xi′) and Party 2 communication corruption detection module 335-j performs a check that hashi′(initial vidi′, Xi′)=hashi(initial vidi, Xi)′ for i=1 to n, i≠j. If the check fails Party j communication corruption detection module 335-j determines that a communication corruption exists and Party j communication module 320-j stops sending vidj (2070).

Vidj and vidi may include imagery of the faces/body of Party j and Party i and/or their local environments. Initial vidj should have a continuity relationship with ongoing vidj. Ongoing vid i′ should be displayed by Party j user interface module 325-j. Ongoing vidi′ should have feedback through video content responsive to vidj. There should be randomness of video content including in initial vidj and in initial vidi. In some embodiments Party 1 communication corruption detection module 335-j may stop sending vidj when initial vidj or initial vidi′ is low entropy, which may occur with lens cover or incorrect camera settings.

Party j continuity checking module 330-j checks that initial vidi′ is continuous with ongoing vidi′ for i=1 to n, i j. If the check fails Party j communication corruption detection module 335-j determines that a communication corruption exists and Party j communication module 320-j stops sending vidj (2080). Continuity checking may be performed in many ways. In some embodiments it may involve Party j continuity checking module 330-j determining whether image features between initial vidi′ and ongoing vidi′ are consistent within a predetermined error threshold automatically. In some embodiments it may involve Party j user interface module 325-j displaying initial vidi′ side-by-side, overlapped or differenced with ongoing vidi′ and prompting Party j for user input about consistency which influences Party j continuity checking module 330-j. Displayed images may exaggerate inconsistencies or highlight image regions based on the magnitude of automatically determined error. Supporting methods used by the continuity checking module 330-j in some embodiments may include motion tracking of local features and object models for tracking objects.

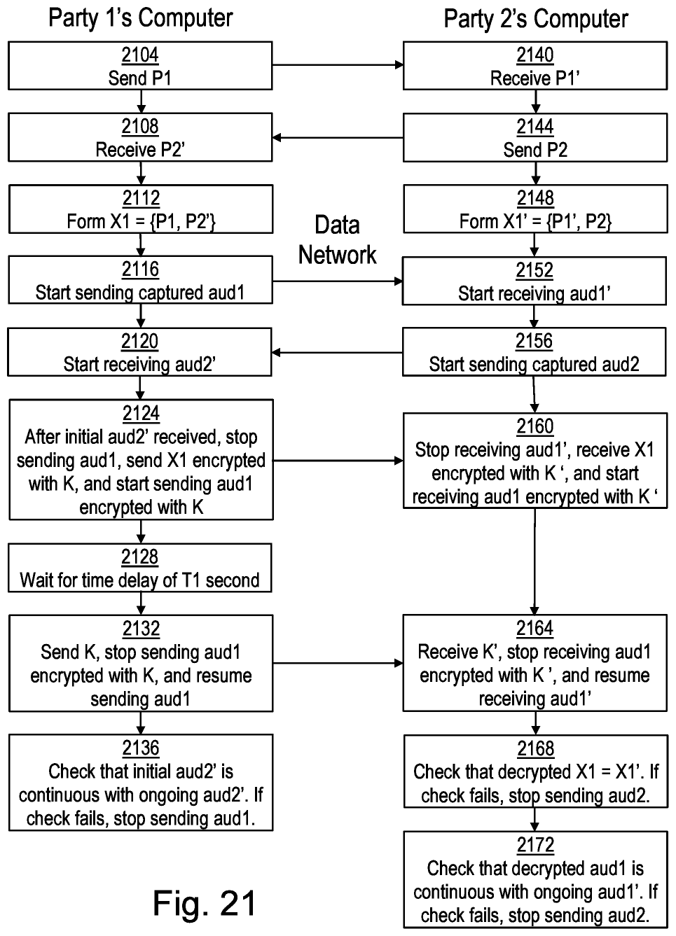

Embodiments related to FIG. 21 are similar to embodiments related to FIG. 5.

Party 1 call initialisation module 305-1 and Party 2 call initialisation module 305-2 initialise a data communication session. Party 1 communication module 320-1 sends P1 to Party 2 (2104) and Party 2 communication module 320-2 receives P1′ purportedly from Party 1 (2140). Party 2 communication module 320-2 sends P2 to Party 1 (2144) and Party 1 communication module 320-1 receives P2′ purportedly from Party 2 (2108). Party 1 call initialisation module 305-1 forms X1 data as the concatenation of P1 and P2′ (2112) and Party 2 call initialisation module 305-2 forms X1′ data as the concatenation of P1′ and P2 (2148).

Party 1 video and/or audio capture module 310-1 starts capture of Party 1 audio aud1 (2116) and Party 1 communication module 320-1 sends aud1 to Party 2 (2116). Party 2 communication module 320-2 receives aud1′ purportedly from Party 1 (2152). Party 2 video and/or audio capture module 310-2 starts capture of Party 2 audio aud2 and Party 2 communication module 320-2 sends aud2 to Party 1 (2156). Party 1 communication module 320-1 starts receiving aud2′ purportedly from Party 2 (2120). Once Party 1 communication module 320-1 receives some initial aud2′ containing speech (speech may be automatically detected), and at a time when aud1 presently contains speech (speech may be automatically detected) Party 1 encoding module 315-1 produces X1 encrypted with a randomly generated AES key K and aud1 encrypted with the same key. Encryption methods other than AES may be used. Party 1 communication module 320-1 sends X1 encrypted with K and starts sending aud1 encrypted with K to Party 2 (2124). After a time delay of T1 seconds (which may be 2 seconds in some embodiments) (2128), Party 1 communication module 320-1 sends K and resumes sending aud1 not encrypted with K to Party 2 (2132). Party 2 communication module 320-2 receives X1 encrypted with K and starts receiving aud1 encrypted with K purportedly from party 1 (2160). Later party 2 communication module 320-2 receives K′ and resumes receiving aud1′ purportedly from party 1 (2164).

Party 2 encoding module 315-2 forms decrypted X1 using K′ and Party 2 communication corruption detection module 335-2 performs a check that decrypted X1=X1′. If the check fails Party 2 communication corruption detection module 335-2 determines that a communication corruption exists and Party 2 communication module 320-2 stops sending aud2 (2168).

Initial aud2′ and ongoing aud2′ should be displayed by Party 1 user interface module 325-1 as it is received. Prior to receiving encrypted aud1′, ongoing aud1′ should be displayed by Party 2 user interface module 325-2 as it is received. Just before K′ is received some of the last displayed audio may be redisplayed at faster than normal speed to blend in with decrypted aud1 displayed at faster than normal speed. Further received ongoing aud1′ is displayed at faster than normal speed until the ongoing aud1′ being received is displayed in real-time.

Aud2 may include audio of the speech of Party 2 and/or Party 2 local environment. Aud1 may include audio of the speech of Party 1 and/or Party 1 local environment. Initial aud2 should have a continuity relationship with ongoing aud2. Aud1 that is encrypted should have a continuity relationship with ongoing aud1. Aud2′ should have feedback through audio content responsive to aud1. Aud1′ should have feedback through audio content responsive to aud2. There should be randomness of audio content including in initial aud2 and in aud1 that is encrypted.

Party 1 continuity checking module 330-1 checks that initial aud2′ is continuous with ongoing aud2′. If the check fails Party 1 communication corruption detection module 335-1 determines that a communication corruption exists and Party 1 communication module 320-1 stops sending aud1 (2136). Continuity checking may be performed in many ways. In some embodiments it may involve Party 1 continuity checking module 330-1 determining whether audio features between initial aud2′ and ongoing aud2′ are consistent within a predetermined error threshold automatically. In some embodiments it may involve Party 1 user interface module 325-1 displaying initial aud2′ before ongoing aud2′ and prompting Party 1 for user input about consistency which influences Party 1 continuity checking module 330-1. Displayed audio may exaggerate inconsistencies or highlight audio regions based on the magnitude of automatically determined error. Supporting methods used by the continuity checking module 330-1 in some embodiments may include background noise processing and speech processing.

Party 1 continuity checking module 330-2 checks that decrypted aud1 is continuous with ongoing aud1′. If the check fails Party 2 communication corruption detection module 335-2 determines that a communication corruption exists and Party 2 communication module 320-2 stops sending aud2 (2172). Continuity checking may be performed in many ways. In some embodiments it may involve Party 2 continuity checking module 330-2 determining whether audio features between decrypted aud1 and ongoing aud1′ are consistent within a predetermined error threshold automatically. In some embodiments it may involve Party 2 user interface module 325-2 displaying decrypted aud1′ immediately after and/or before ongoing aud1′ received before and/or after encrypted aud1 respectively and prompting Party 2 for user input about consistency which influences Party 2 continuity checking module 330-2. Displayed audio may exaggerate inconsistencies or highlight audio regions based on the magnitude of automatically determined error. Supporting methods used by the continuity checking module 330-2 in some embodiments may include background noise processing and speech processing.

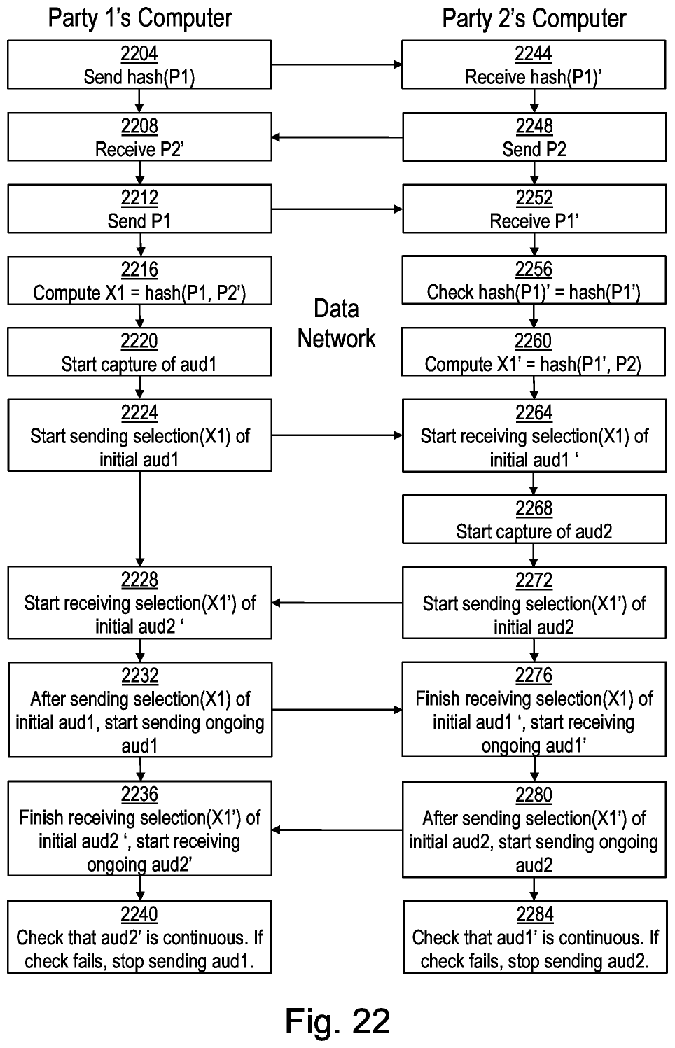

Embodiments related to FIG. 22 are similar to embodiments related to FIG. 5.

Party 1 call initialisation module 305-1 and Party 2 call initialisation module 305-2 initialise a data communication session. Party 1 call initialisation module 305-1 applies a hash function to previously undisclosed P1 to produce hash(P1). The hash function may be a cryptographic hash function. Party 1 communication module 320-1 sends hash(P1) to Party 2 (2204) and Party 2 communication module 320-2 receives hash(P1)′ purportedly from Party 1 (2244). Party 2 communication module 320-2 sends previously undisclosed P2 to Party 1 (2248) and Party 1 communication module 320-1 receives P2′ purportedly from Party 2 (2208). Party 1 communication module 320-1 sends P1 to Party 2 (2212) and Party 2 communication module 320-2 receives P1′ purportedly from Party 1 (2252). Party 2 call initialisation module 305-2 applies the same hash function purportedly used to create hash(P1)′ to P1′ to produce hash′ (P1). Party 2 communication corruption detection module 335-2 performs a check (2256) that hash′ (P1′)=hash(P1)′. If the check fails Party 2 communication corruption detection module 335-2 determines that a communication corruption exists and terminates the call. Party 1 call initialisation module 305-1 forms 16 bit X1 data by applying a hash function to the concatenation of P1 and P2′ (2216) and Party 2 call initialisation module 305-2 forms 16 bit X1′ data by applying the same hash function to the concatenation of P1′ and P2 (2260). The X1 and X1′ data may be less than 16 bits or longer than 16 bits in some embodiments.

Party 1 video and/or audio capture module 310-1 starts capture of Party 1 aud1 (2220). Party 1 encoding module 315-1 selects a selection mask based on X1 and selects time segments corresponding to the selection mask from streamed initial aud1 for Party 1 communication module 320-1 to stream to Party 2. The selection mask may be 20 seconds long with four 0.75 second long sections not selected, where: the first 0.75 long section may start at any 0.25 interval between 2 seconds and 5.75 seconds inclusive, the second 0.75 long section may start at any 0.25 interval between 6.5 seconds and 10.25 seconds inclusive, the third 0.75 long section may start at any 0.25 interval between 11 seconds and 14.75 seconds inclusive, and the fourth 0.75 long section may start at any 0.25 interval between 15.5 seconds and 19.25 seconds inclusive. Thus the selection mask selection(X1) may be 1 of out of 65,536 possible selection masks. Other sets of selection masks may be used. Party 1 communication module 320-1 starts streaming selection(X1) of initial aud1 to Party 2 (2224) and Party 2 communication module 320-2 starts receiving selection(X1) of initial aud1′ (2264). Party 2 video and/or audio capture module 310-2 starts capture of Party 2 audio aud2 (2268). Party 2 encoding module 315-2 selects a selection mask based on X1′ and selects time segments corresponding to the selection mask from streamed initial aud2 for Party 2 communication module 320-2 to stream to Party 1. The selection mask may be 20 seconds long with four 0.75 second long sections not selected, where: the first 0.75 long section may start at any 0.25 interval between 2 seconds and 5.75 seconds inclusive, the second 0.75 long section may start at any 0.25 interval between 6.5 seconds and 10.25 seconds inclusive, the third 0.75 long section may start at any 0.25 interval between 11 seconds and 14.75 seconds inclusive, and the fourth 0.75 long section may start at any 0.25 interval between 15.5 seconds and 19.25 seconds inclusive. Thus the selection mask selection(X1′) may be 1 of out of 65,536 possible selection masks. Other sets of selection masks may be used but both Party 1 and Party 2 should use the same set of selection masks which in some embodiments may be fixed. Party 2 communication module 320-2 starts streaming selection(X1′) of initial aud2 to Party 1 (2272) and Party 1 communication module 320-1 starts receiving selection(X1′) of initial aud2 ‘ (2228). After selection(X1) of initial aud1 has been sent Party 1 communication module 320-1 starts sending ongoing aud1 (2232). After selection(X1’) of initial aud2 has been sent Party 2 communication module 320-2 starts sending ongoing aud2 (2280). Party 2 communication module 320-2 starts receiving ongoing aud1′ (2276). Party 1 communication module 320-1 starts receiving ongoing aud2′ (2236).

Party 1 user interface module 325-1 displays selection(X1′) of initial aud2 ‘ and ongoing aud2’ as it is received. Party 2 user interface module 325-2 displays selection(X1) of initial aud1 ‘ and ongoing aud1’ as it is received.

Aud2 may include audio of the speech of Party 2 and/or Party 2 local environment. Aud1 may include audio of the speech of Party 1 and/or Party 1 local environment. Aud2 should be continuous. Aud1 should be continuous. Aud2′ should have feedback through audio content responsive to aud1. Aud1′ should have feedback through audio content responsive to aud2. There should be randomness of audio content including in initial aud2 and in initial aud1.

Party 1 continuity checking module 330-1 checks that selection(X1′) of initial aud2′ and ongoing aud2′, is continuous except during the 0.75 second intervals when selection(X1) is preventing sending of initial aud1 by Party 1 communication module 320-1. Party 1 user interface module 325-1 may display a special sound such as a continuous hiss or tone (Party 1 continuity checking module 330-1 may check audio features in selection(X1′) of initial aud2′ for any special sound which should not be present in received audio), or a vibration, or a visual signal during such 0.75 intervals. Such intervals should approximately (depending on latency) coincide with missing initial aud2′. Continuity checking may be performed in many ways. In some embodiments it may involve Party 1 continuity checking module 330-1 determining whether audio features in selection(X1′) of initial aud2′ and ongoing aud2′ are consistent within a predetermined error threshold automatically. In some embodiments continuity checking may involve Party 1 user interface module 325-1 displaying selection(X1′) of initial aud2 ‘ and ongoing aud2’ and prompting for user input about continuity which influences Party 1 continuity checking module 330-1. If the check fails Party 1 communication corruption detection module 335-1 determines that a communication corruption exists and Party 1 communication module 320-1 stops sending aud2 (2240). Supporting methods used by the continuity checking module 330-1 in some embodiments may include background noise processing and speech processing.

Party 2 continuity checking module 330-2 checks that selection(X1) of initial aud1′ and ongoing aud1′, is continuous except during the 0.75 second intervals when selection(X1′) is preventing sending of initial aud2 by Party 2 communication module 320-2. Party 2 user interface module 325-2 may display a special sound such as a continuous hiss or tone (Party 2 continuity checking module 330-2 may check audio features in selection(X1) of initial aud1′ for any special sound which should not be present in received audio), or a vibration, or a visual signal during such 0.75 intervals. Such intervals should approximately (depending on latency) coincide with missing initial aud1′. Continuity checking may be performed in many ways. In some embodiments it may involve Party 2 continuity checking module 330-2 determining whether audio features in selection(X1) of initial aud1′ and ongoing aud1′ are consistent within a predetermined error threshold automatically. In some embodiments continuity checking may involve Party 2 user interface module 325-2 displaying selection(X1) of initial aud1 ‘ and ongoing aud1’ and prompting for user input about continuity which influences Party 2 continuity checking module 330-2. If the check fails Party 2 communication corruption detection module 335-2 determines that a communication corruption exists and Party 2 communication module 320-2 stops sending aud2 (2284). Supporting methods used by the continuity checking module 330-2 in some embodiments may include background noise processing and speech processing.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method of communication between a first computer and a second computer over a network, the method comprising:
establishing a data communication session between the first computer and the second computer;
receiving in real time at the first computer a secure source of streamed first video and/or audio data;
generating an encoded representation of at least a first part of the first video and/or audio data, wherein the encoded representation further comprises data to be authenticated by the second computer as being from the first computer;
transmitting the encoded representation to the second computer;
transmitting at least a second part of the first streamed video and/or audio data to the second computer, wherein the at least first part of the first video and/or audio data has a first continuity relationship with the at least second transmitted first streamed video and/or audio data;
receiving a first part of second streamed video and/or audio data purportedly from the second computer;
receiving at the first computer a second part of the second streamed video and/or audio data purportedly from the second computer and displaying at the first computer images and/or sound corresponding to the second part of the second streamed video and/or audio data, wherein the second part of the second streamed video and/or audio data comprises feedback video and/or audio data responsive to at least another part of the transmitted first streamed video and/or audio data;
determining whether the first part of second streamed video and/or audio data has a predetermined second continuity relationship with the second part of the second streamed video and/or audio data; and
determining the existence of a communication corruption if it is determined that the first part of second streamed video and/or audio data and the second part of the second streamed video and/or audio data do not have the predetermined second continuity relationship.

2. The method of claim 1, wherein the encoded representation is generated by the first computer using a selected part of the secure source of streamed first video and/or audio as the first part of the first video and/or audio data, wherein the selected part is based on the data to be authenticated.

3. The method of claim 2, wherein the selected part is determined based on an output of at least one mathematical function that is applied by the first computer to the data to be authenticated to specify one of a plurality of selection masks to be used by the first computer in generating the encoded representation.

4. The method of any one of claims 1 to 3, wherein the encoded representation comprises a plurality of selected parts of the secure source of streamed first video and/or audio data as the first part of the first video and/or audio data, wherein the transmitting of the encoded representation comprises transmitting different ones of the selected parts at selected times within a predetermined period after establishing the data communication session.

5. The method of claim 4, wherein the selected times are determined based on an output of at least one mathematical function that is applied by the first computer to the data to be authenticated.

6. The method of any one of claims 1 to 5, wherein the at least first part of the first video and/or audio data cannot be recovered from the encoded representation, the method further comprising transmitting to the second computer one of: the at least first part of the first video and/or audio data; and recovery data that allows recovery of the at least first part of the first part of the first video and/or audio data.

7. The method of any one of claims 1 to 6, wherein the first continuity relationship requires that image features and/or audio features of respective first video and/or audio data are consistent between the transmitted first streamed video and/or audio data and the at least first part of the first video and/or audio data, such that an error metric between the transmitted first streamed video and/or audio data and the at least first part of the first video and/or audio data is satisfied to within a predetermined error threshold.

8. The method of any one of claims 1 to 7, wherein the second continuity relationship requires that image features and/or audio features of respective second video and/or audio data are consistent between the first part of second streamed video and/or audio data and the second part of second streamed video and/or audio data, such that an error metric between the first part of second streamed video and/or audio data and the second part of second streamed video and/or audio data is satisfied to within a predetermined error threshold.

9. A method of communication between a first computer and a second computer over a network, the method comprising:
establishing a data communication session between the first computer and the second computer;
receiving in real time at the first computer a secure source of streamed first video and/or audio data;
receiving an encoded representation of at least a first part of second streamed video and/or audio data purportedly from the second computer, wherein the encoded representation further comprises data to be authenticated by the first computer as being from the second computer;
transmitting at least a first part of the first video and/or audio data to the second computer;
transmitting at least a second part of the first streamed video and/or audio data to the second computer, wherein the at least second part of the first streamed video and/or audio data has a first continuity relationship with the transmitted first part of the first video and/or audio data;
receiving at the first computer a second part of the second streamed video and/or audio data purportedly from the second computer and displaying at the first computer images and/or sound corresponding to the second part of the second streamed video and/or audio data, wherein the second part of the second streamed video and/or audio data comprises feedback video and/or audio data responsive to at least another part of the transmitted first streamed video and/or audio data;
determining whether the first part of second streamed video and/or audio data has a predetermined second continuity relationship with the second part of the second streamed video and/or audio data; and
determining the existence of a communication corruption if it is determined that the first part of second streamed video and/or audio data and the second part of the second streamed video and/or audio data do not have the predetermined second continuity relationship.

10. The method of claim 9, wherein the at least first part of the first video and/or audio data cannot be recovered from the encoded representation, the method further comprising receiving at the first computer purportedly from the second computer one of: the at least first part of the first video and/or audio data; and recovery data that allows recovery by the first computer of the at least first part of the first part of the first video and/or audio data.

11. The method of claim 9 or claim 10, wherein the first continuity relationship requires that image features and/or audio features of respective first video and/or audio data are consistent between the transmitted first streamed video and/or audio data and the at least first part of the first video and/or audio data, such that an error metric between the transmitted first streamed video and/or audio data and the at least first part of the first video and/or audio data is satisfied to within a predetermined error threshold.

12. The method of any one of claims 9 to 11, wherein the second continuity relationship requires that image features and/or audio features of respective second video and/or audio data are consistent between the first part of second streamed video and/or audio data and the second part of second streamed video and/or audio data, such that an error metric between the first part of second streamed video and/or audio data and the second part of second streamed video and/or audio data is satisfied to within a predetermined error threshold.

13. The method of any one of claims 1 to 12, further comprising flagging the communication corruption if it is determined to exist.

14. The method of claim 13, wherein the flagging comprises at least one of: logging the occurrence of the communication corruption in data records of the first computer; and providing a visual and/or audio and/or sensory indication of the existence of the communication corruption via the first computer.

15. The method of any one of claims 1 to 14, further comprising terminating the data communication session if the communication corruption is determined to exist.

16. A system comprising means for performing the method of any one of claims 1 to 15.

17. Computer-readable storage storing executable program code which, when executed by a computer, causes the computer to perform the method of any one of claims 1 to 15.

18. A first computer configured for communication with a second computer over a network, the first computer comprising:
a call initialisation module for establishing a data communication session between the first computer and the second computer;
a video and/or audio capture module for receiving in real time at the first computer a secure source of streamed first video and/or audio data;
an encoding module for generating an encoded representation of at least a first part of the first video and/or audio data, wherein the encoded representation further comprises data to be authenticated by the second computer as being from the first computer;
a communication module configured to transmit the encoded representation to the second computer and to transmit at least a second part of the first streamed video and/or audio data to the second computer, wherein the at least first part of the first video and/or audio data has a first continuity relationship with the at least second transmitted first streamed video and/or audio data;
the communication module being further configured to receive a first part of second streamed video and/or audio data purportedly from the second computer and to receive a second part of the second streamed video and/or audio data purportedly from the second computer;
a user interface module for displaying at the first computer images and/or sound corresponding to the second part of the second streamed video and/or audio data, wherein the second part of the second streamed video and/or audio data comprises feedback video and/or audio data responsive to at least another part of the transmitted first streamed video and/or audio data;
a continuity checking module for determining whether the first part of second streamed video and/or audio data has a predetermined second continuity relationship with the second part of the second streamed video and/or audio data; and
a communication corruption detection module for determining the existence of a communication corruption if the continuity checking module determines that the first part of second streamed video and/or audio data and the second part of the second streamed video and/or audio data do not have the predetermined second continuity relationship.

19. The computer of claim 18, wherein the encoded representation is generated by the encoding module using a selected part of the secure source of streamed first video and/or audio as the first part of the first video and/or audio data, wherein the selected part is based on the data to be authenticated.

20. The computer of claim 19, wherein the selected part is determined by the encoding module based on an output of at least one mathematical function that is applied by the encoding module to the data to be authenticated to specify one of a plurality of selection masks to be used by the encoding module in generating the encoded representation.

21. The computer of any one of claims 18 to 20, wherein the encoded representation comprises a plurality of selected parts of the secure source of streamed first video and/or audio data as the first part of the first video and/or audio data, wherein the transmission of the encoded representation by the communication module comprises transmitting different ones of the selected parts at selected times within a predetermined period after establishing the data communication session.

22. The computer of claim 21, wherein the selected times are determined based on an output of at least one mathematical function that is applied by the encoding module to the data to be authenticated.

23. The computer of any one of claims 18 to 22, wherein the at least first part of the first video and/or audio data cannot be recovered from the encoded representation, and wherein the communication module is further configured to transmit to the second computer one of: the at least first part of the first video and/or audio data; and recovery data that allows recovery of the at least first part of the first part of the first video and/or audio data.

24. The computer of any one of claims 18 to 23, wherein the first continuity relationship requires that image features and/or audio features of respective first video and/or audio data are consistent between the transmitted first streamed video and/or audio data and the at least first part of the first video and/or audio data, such that an error metric between the transmitted first streamed video and/or audio data and the at least first part of the first video and/or audio data is satisfied to within a predetermined error threshold.

25. The computer of any one of claims 18 to 24, wherein the second continuity relationship requires that image features and/or audio features of respective second video and/or audio data are consistent between the first part of second streamed video and/or audio data and the second part of second streamed video and/or audio data, such that an error metric between the first part of second streamed video and/or audio data and the second part of second streamed video and/or audio data is satisfied to within a predetermined error threshold.

26. A first computer configured for communication with a second computer over a network, the first computer comprising:
a call initialisation module for establishing a data communication session between the first computer and the second computer;
a video and/or audio capture module for receiving in real time at the first computer a secure source of streamed first video and/or audio data;
a communication module configured to:
receive an encoded representation of at least a first part of second streamed video and/or audio data purportedly from the second computer, wherein the encoded representation further comprises data to be authenticated by the first computer as being from the second computer,
transmit at least a first part of the first video and/or audio data to the second computer,
transmit at least a second part of the first streamed video and/or audio data to the second computer, wherein the at least second part of the first streamed video and/or audio data has a first continuity relationship with the transmitted first part of the first video and/or audio data, and
receive at the first computer a second part of the second streamed video and/or audio data purportedly from the second computer;
a user interface module to display at the first computer images and/or sound corresponding to the second part of the second streamed video and/or audio data, wherein the second part of the second streamed video and/or audio data comprises feedback video and/or audio data responsive to at least another part of the transmitted first streamed video and/or audio data;
a continuity checking module to determine whether the first part of second streamed video and/or audio data has a predetermined second continuity relationship with the second part of the second streamed video and/or audio data; and
a communication corruption detection module for determining the existence of a communication corruption in response to the continuity checking module determining that the first part of second streamed video and/or audio data and the second part of the second streamed video and/or audio data do not have the predetermined second continuity relationship.

27. The computer of claim 26, wherein the at least first part of the first video and/or audio data cannot be recovered from the encoded representation, wherein the communication module is configured to receive purportedly from the second computer one of: the at least first part of the first video and/or audio data; and recovery data that allows recovery by the first computer of the at least first part of the first part of the first video and/or audio data.

28. The computer of claim 26 or claim 27, wherein the first continuity relationship requires that image features and/or audio features of respective first video and/or audio data are consistent between the transmitted first streamed video and/or audio data and the at least first part of the first video and/or audio data, such that an error metric between the transmitted first streamed video and/or audio data and the at least first part of the first video and/or audio data is satisfied to within a predetermined error threshold.

29. The computer of any one of claims 26 to 28, wherein the second continuity relationship requires that image features and/or audio features of respective second video and/or audio data are consistent between the first part of second streamed video and/or audio data and the second part of second streamed video and/or audio data, such that an error metric between the first part of second streamed video and/or audio data and the second part of second streamed video and/or audio data is satisfied to within a predetermined error threshold.

30. The computer of any one of claims 26 to 29, wherein the communication corruption detection module is further configured to flag the communication corruption if it is determined to exist, wherein the flagging comprises at least one of: logging the occurrence of the communication corruption in data records of the first computer; and providing a visual and/or audio and/or sensory indication of the existence of the communication corruption via the first computer.

31. The computer of any one of claims 26 to 30, wherein the communication corruption detection module is further configured to terminate the data communication session if the communication corruption is determined to exist.
